(19) United States
(12) Patent Application Publication
(10) Pub. No.: US 2025/0019485 A1
(43) Pub. Date: Jan. 16, 2025

(54) NOVEL POLYETHER POLYOL BLENDS, A PROCESS FOR THEIR PREPARATION, FOAMS PREPARED FROM THESE POLYETHER POLYOL BLENDS AND A PROCESS FOR THEIR PREPARATION

(71) Applicant: Covestro LLC, Pittsburgh, PA (US)

(72) Inventors: Sharlene A. Lewis, Pittsburgh, PA (US); Jack R. Reese, Renfrew, PA (US); Nigel Barksby, Moon Township, PA (US); Brian L. Neal, Pittsburgh, PA (US)

(21) Appl. No.: 18/903,556

(22) Filed: Oct. 1, 2024

Related U.S. Application Data
(62) Division of application No. 17/386,798, filed on Jul. 28, 2021.

(51) Int. Cl. C08G 18/48; C08G 18/76; C08G 65/12; C08J 9/12

(52) U.S. Cl. CPC C08G 18/485; C08G 18/4816; C08G 18/4829; C08G 18/7621; C08G 65/12; C08J 9/125; C08G 2110/0083; C08J 2203/10; C08J 2375/08

(57) ABSTRACT

This invention relates to a novel polyether polyol blend having an overall hydroxyl number of 56 mg KOH/g to 140 mg KOH/g, an overall functionality of greater than 2, and an overall content of copolymerized oxyethylene of 20% to 40% by weight. These novel polyether polyol blends may also be in-situ formed novel polyether polyol blends. A process for preparing these novel polyether polyol blends is also disclosed. These novel polyether polyol blends are suitable for preparing viscoelastic flexible polyurethane foams, and in a process for preparing viscoelastic foams.

### FIELD

The invention relates to novel polyether polyol blends, a process for preparing these novel polyether polyol blends, viscoelastic flexible polyurethane foams comprising these novel polyether polyol blends, and a process for preparing these viscoelastic polyurethane foams from these novel polyether polyol blends. The novel polyether polyol blends provide simpler formulation processes by reducing the number of polyether polyols needed in the formulation while maintaining good physical properties in foams comprising these novel polyether polyol blends.

### BACKGROUND

The popularity of viscoelastic polyurethane foam, also referred to as memory foam or low resilience foam, has significantly increased in recent years as pillows, toppers or layers in mattresses and bed in a box foams. It is also used in other home and office furnishings as well as automotive applications. This increased use has created a demand for better quality viscoelastic foams with high air flows and improved physical properties such as reduced compression sets and better tear strength.

### SUMMARY

The novel polyether polyol blends have an overall hydroxyl number of 56 mg KOH/g to 140 mg KOH/g, an overall functionality of greater than 2, and an overall content of copolymerized oxyethylene of 20 to 40% by weight. These novel polyether polyol blends comprise:
(a) a monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a),
(b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block, and
(c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block;
   wherein the novel polyether polyol blend comprises (i) 20 to 50% by weight of (a) the monol initiated oxyalkylene ether and (ii) 80 to 50% by weight of polyether polyols (b) and (c), with the sum of the %'s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.

The invention also relates to novel in-situ formed polyether polyol blends having an overall hydroxyl number of 56 mg KOH/g to 140 mg KOH/g, an overall functionality of greater than 2, and an overall content of copolymerized oxyethylene of 20 to 40% by weight. These novel in-situ formed polyether polyol blends comprise:
(a) a monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a),
(b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block, and
(c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block;
   wherein the novel in-situ formed polyether polyol blend comprises (i) 20 to 50% by weight of (a) the monol initiated oxyalkylene ether and (ii) 80 to 50% by weight of polyether polyols (b) and (c), with the sum of the %' s by weight of (i) and (ii) totaling 100% by weight of the novel in-situ formed polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.

The process of preparing the novel in-situ formed polyether polyol blend having an overall hydroxyl number of 56 mg KOH/g to 140 mg KOH/g, an overall functionality greater than 2, and an overall content of copolymerized oxyethylene of 20% to 40% by weight, comprises:
I) introducing into a reaction vessel a mixture comprising:
   (1) an initially charged starter (Sᵢ) comprising a monofunctional compound having a hydroxyl number of less than or equal to 80, and
   (2) a DMC (double metal cyanide) catalyst;
II) feeding
   (1) an epoxide comprising propylene oxide and ethylene oxide in a weight ratio of 100:0 to 80:20,
into the reaction vessel;
III) allowing the epoxide mixture and the initially charged starter (Sᵢ) to react and to polymerize by feeding the epoxide until the equivalent weight of the monofunctional compound is increased by at least 10% by weight and reaches a value between 1,500 and 6,000;
IV) feeding
   (1) an epoxide comprising propylene oxide and ethylene oxide in a weight ratio of 78:22 to 45:55;
   while continuously adding
   (2) a low equivalent weight continuously added starter (S_{c}) having a nominal functionality of greater than 2 to 6, and an equivalent weight of 28 to 400,
   into the reaction vessel while continuing to feed epoxide;
V) completing addition of the low equivalent weight continuously added starter (S_{c});
VI) feeding
   (1) an epoxide comprising propylene oxide and ethylene oxide fed at the same ratio as IV)(1) to fully react all the low equivalent weight continuously added starter (S_{c});
VII) allowing the mixture to continue to polymerize in the reaction vessel thereby forming
   (1) a polyether polyol with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1);
VIII) feeding
   (1) an epoxide comprising propylene oxide and ethylene oxide;
IX) allowing the mixture to continue to polymerize in the reaction vessel thereby forming
   (1) a polyether polyol with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1), and a second oxide block comprising 10 to 50% by weight of copolymerized oxyethylene, based on the weight of epoxide added in VIII)(1);
X) thereby forming
   (1) a novel in-situ formed polyether polyol blend which has an overall hydroxyl number of 56 mg KOH/g to 140 mg KOH/g, an overall functionality of greater than 2, and an overall content of copolymerized oxyethylene of 20% to 40% by weight, and which comprises
      (a) a monol initiated oxyalkylene ether having a hydroxyl number of less than or equal to 56 mg KOH/g, and containing less than or equal to 20% by weight of copolymerized oxyethylene, based on 100% by weight of (a),
      (b) a polyether polyol having a hydroxyl number of 47 to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10% to 50% by weight of copolymerized oxyethylene, based on the weight of the second oxide block,
      and
      (c) a polyether polyol having a hydroxyl number of 47 to 300 mg KOH/g, and a nominal functionality of greater than 2 to 8, with the polyether polyol comprising a first oxide block having 20% to 50% by weight of copolymerized oxyethylene, based on the weight of the polyether polyol at the end of the first oxide block, and a second oxide block comprising 10 to 50% by weight of copolymerized oxyethylene, based on the weight of the second oxide block;
wherein the novel in-situ formed polyether polyol blend comprises (i) 20% to 50% by weight of (a) the monol initiated oxyalkylene ether, and (ii) 80 to 50% by weight of polyether polyols (b) and (c), with the sum of the %'s by weight totaling 100% by weight of the novel in-situ formed polyether polyol blend, and wherein (ii) the 80 to 50% by weight of polyether polyols (b) and (c) comprises polyether polyol (b) in an amount of from 10 to 90% by weight and polyether polyol (c) in an amount of 90 to 10% by weight.

The invention also relates to a viscoelastic polyurethane foam comprising the reaction product of:
(A) toluene diisocyanate,
with
(B) an isocyanate-reactive component comprising
   (1) a novel polyether polyol blend having an overall hydroxyl number of 56 mg KOH/g to 140 mg KOH/g, an overall functionality of greater than 2, and an overall content of copolymerized oxyethylene of 20 to 40% by weight, which comprises:
      (a) a monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a),
      (b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block,
      and
      (c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block;
      wherein the novel polyether polyol blend comprises (i) 20 to 50% by weight of (a) the monol initiated oxyalkylene ether and (ii) 80 to 50% by weight of polyether polyols (b) and (c), with the sum of the %' s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight;
in the presence of:
(C) a blowing agent;
(D) a catalyst;
and
(E) a surfactant.

The invention also relates to a process for the preparation of a viscoelastic foam.

This process comprises reacting:
(A) toluene diisocyanate,
with
(B) an isocyanate-reactive component comprising:
   (1) a novel polyether polyol blend having an overall hydroxyl number of 56 mg KOH/g to 140 mg KOH/g, an overall functionality of greater than 2, and an overall content of copolymerized oxyethylene of 20 to 40% by weight, which comprises:
      (a) a monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a),
      (b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block,
      and
      (c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block;
      wherein the novel polyether polyol blend comprises (i) 20 to 50% by weight of (a) the monol initiated oxyalkylene ether and (ii) 80 to 50% by weight of polyether polyols (b) and (c), with the sum of the %' s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight;
in the presence of:
(C) a blowing agent;
(D) a catalyst;
and
(E) a surfactant.

### DETAILED DESCRIPTION

Various embodiments are described and illustrated in this specification to provide an overall understanding of the structure, function, properties, and use of the disclosed inventions. It is understood that the various embodiments described and illustrated in this specification are non-limiting and non-exhaustive. Thus, the invention is not limited by the description of the various non-limiting and non-exhaustive embodiments disclosed in this specification. The features and characteristics described in connection with various embodiments may be combined with the features and characteristics of other embodiments. Such modifications and variations are intended to be included within the scope of this specification. As such, the claims may be amended to recite any features or characteristics expressly or inherently described in, or otherwise expressly or inherently supported by, this specification. Further, Applicant(s) reserve the right to amend the claims to affirmatively disclaim features or characteristics that may be present in the prior art. Therefore, any such amendments comply with the requirements of 35 U.S.C. § 112 and 35 U.S.C. § 132(a). The various embodiments disclosed and described in this specification can comprise, consist of, or consist essentially of the features and characteristics as variously described herein.

Any patent, publication, or other disclosure material identified herein is incorporated by reference into this specification in its entirety unless otherwise indicated, but only to the extent that the incorporated material does not conflict with existing definitions, statements, or other disclosure material expressly set forth in this specification. As such, and to the extent necessary, the express disclosure as set forth in this specification supersedes any conflicting material incorporated by reference herein. Any material, or portion thereof, that is said to be incorporated by reference into this specification, but which conflicts with existing definitions, statements, or other disclosure material set forth herein, is only incorporated to the extent that no conflict arises between that incorporated material and the existing disclosure material. Applicant(s) reserves the right to amend this specification to expressly recite any subject matter, or portion thereof, incorporated by reference herein.

In this specification, other than where otherwise indicated, all numerical parameters are to be understood as being prefaced and modified in all instances by the term “about”, in which the numerical parameters possess the inherent variability characteristic of the underlying measurement techniques used to determine the numerical value of the parameter. At the very least, and not as an attempt to limit the application of the doctrine of equivalents to the scope of the claims, each numerical parameter described in the present description should at least be construed in light of the number of reported significant digits and by applying ordinary rounding techniques.

Also, any numerical range recited in this specification is intended to include all sub-ranges of the same numerical precision subsumed within the recited range. For example, a range of “1.0 to 10.0” is intended to include all sub-ranges between (and including) the recited minimum value of 1.0 and the recited maximum value of 10.0, that is, having a minimum value equal to or greater than 1.0 and a maximum value equal to or less than 10.0, such as, for example, 2.4 to 7.6. All end points of any range are included unless specified otherwise. Any maximum numerical limitation recited in this specification is intended to include all lower numerical limitations subsumed therein and any minimum numerical limitation recited in this specification is intended to include all higher numerical limitations subsumed therein. Accordingly, Applicant(s) reserves the right to amend this specification, including the claims, to expressly recite any sub-range subsumed within the ranges expressly recited herein. All such ranges are intended to be inherently described in this specification such that amending to expressly recite any such sub-ranges would comply with the requirements of 35 U.S.C. § 112 and 35 U.S.C. § 132(a).

The grammatical articles “one”, “a”, “an”, and “the”, as used in this specification, are intended to include “at least one” or “one or more”, unless otherwise indicated. Thus, the articles are used in this specification to refer to one or more than one (i.e., to “at least one”) of the grammatical objects of the article. By way of example, “a component” means one or more components, and thus, possibly, more than one component is contemplated and may be employed or used in an implementation of the described embodiments. Further, the use of a singular noun includes the plural, and the use of a plural noun includes the singular, unless the context of the usage requires otherwise.

Equivalent weights and molecular weights given herein in Daltons (Da) are number average equivalent weights and number average molecular weights respectively, unless indicated otherwise, and were determined by GPC as described herein.

All number average and weight average, Mₙ and M_{w}, respectively, molecular weights herein were determined by gel-permeation chromatography (GPC) using a method based on DIN 55672-1 employing chloroform as the eluent with a mixed bed column (Agilent PL Gel; SDVB; 3 micron Pore diameter: 1×Mixed-E+5 micron Pore diameter: 2×Mixed-D), refractive index (RI) detection and calibrated with polyethylene glycol.

All hydroxyl numbers (i.e. OH numbers) herein were determined according to ASTM D4274-11, and are reported in mg KOH/g polyol.

The molecular weight is the number average equivalent weight multiplied by the starter functionality. The hydroxyl number equals 56, 100 divided by the equivalent weight.

As used herein, the term “nominal functionality” refers to the functionality of a polyether polyol which is based solely on the functionality of the starter compound or initiator used in preparing the polyether polyol. The nominal functionality is typically used to describe the functionality of a specific compound.

As used herein, the term “overall functionality” refers to the average number of reactive groups (e.g. hydroxyl, amine, etc.) which are present per molecule of the polyether polyol or polyether polyol blend being described. This term is typically used when either a polyether polyol is prepared from two or more starter compounds or initiators that have different functionalities and/or when a blend of polyether polyols is used in which the individual polyether polyols have different functionalities.

Isocyanate index is the relative stoichiometric amount of isocyanate functional groups necessary to react with the isocyanate reactive groups present in the overall foam formulation. It is expressed as a percentage in this application; thus equal stoichiometric amounts of isocyanate functional groups and isocyanate reactive functional groups in the formulation provide an isocyanate index of 100%.

As used herein, the term “viscoelastic flexible foam” or “viscoelastic flexible polyurethane foam” refers to low-resilience polyurethane foam and is commonly referred to as memory foam. These foams typically provide uniform support of any weight placed on the foam targeted to relieve pressure points, and the foam recovers slowly to its original shape once the weight is removed. These foams are mainly used for bedding, pillows, etc.

As set forth above, the novel polyether polyol blends herein may be physical blends of polyether polyols or they may be in-situ formed polyether polyol blends.

As used herein, the term “in-situ formed” with respect to a polyether polyol blend means producing the polyether polyol blend during the course of an alkoxylation reaction in which at least one epoxide is added to a mixture of an initial starter (Sᵢ) and alkoxylation catalyst to initiate the alkoxylation and then at least one continuous starter (S_{c}) feed is added during the course of the alkoxylation to form a blend of polyether polyols that can vary in molecular weight and functionality.

The novel polyether polyol blends have an overall functionality of greater than 2, an overall hydroxyl number of 56 mg KOH/g to 140 mg KOH/g, and an overall content of copolymerized oxyethylene of 20 to 40% by weight. These polyether polyol blends may also have an overall functionality of greater 2 to 3, and an overall hydroxyl number of 80 mg KOH/g to 120 mg KOH/g. These polyether polyol blends comprise: (a) a monol initiated oxyalkylene ether having a hydroxyl number less than or equal to 56 mg KOH/g, and containing less than or equal to 20% by weight of copolymerized oxyethylene, based on the total weight of monol initiated oxyalkylene ether (a); (b) a polyether polyol having a hydroxyl number of 47 to 300 mg KOH/g, and a nominal functionality of 2, in which the polyether polyol comprises a first oxide block having 20 to 50% by weight of copolymerized oxyethylene, based on the weight of the polyether polyol at the end of the first oxide block, and a second oxide block comprising 10 to 50% by weight of copolymerized oxyethylene, based on the weight of the second oxide block; and (c) a polyether polyol having a hydroxyl number of 47 to 300 mg KOH/g, and a nominal functionality of greater than 2 to 8, in which the polyether polyol comprises a first oxide block having 20 to 50% by weight of copolymerized oxyethylene, based on the weight of the polyether polyol at the end of the first oxide block, and a second oxide block comprising 10 to 50% by weight of copolymerized oxyethylene, based on the weight of the second oxide block; wherein the polyether polyol blend comprises (i) from 20 to 50% by weight of (a) the monol initiated oxyalkylene ether, and (ii) from 80 to 50% by weight of polyether polyols (b) and (c), with the sum of the %'s by weight of (i) and (ii) totaling 100% by weight of the polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.

Suitable monol initiated oxyalkylene ethers (a) have a hydroxyl number of less than or equal to 56 mg KOH/g and contain less than or equal to 20% by weight of copolymerized oxyethylene, based on the total weight of the monol initiated oxyalkylene ether. These monols have a hydroxyl number less than or equal to 56, or less than or equal to 28.

Suitable starters for (a) the monol initiated oxyalkylene ethers include polyoxyalkylene monols formed by addition of multiple equivalents of epoxide to a low equivalent weight monofunctional starter. Low equivalent weight monofunctional starters useful herein may be linear or branched compounds, and/or may be naturally-derived or synthetic compounds. Some examples of suitable low equivalent weight monofunctional starters include compounds such as, for example, methanol, ethanol, phenols, allyl alcohol, butyl carbitol, longer chain alcohols, etc., and mixtures thereof. Examples of suitable longer chain alcohols include C₁₀, C₁₂, C₁₃, C₁₄ and/or C₁₅ monols, which may be used individually or as mixtures. Suitable monoethers include a hydrocarbyl residue (Z) in which the hydrocarbyl residue is a C₄-C₆₀, and preferably a C₉-C₃₀ alkyl, aryl or aralkyl group. The hydrocarbyl residue is typically derived from a monohydroxyl compound such as an alcohol or a phenol. Also suitable are monoethers derived from phenols substituted with C₄-C₁₅ alkyl groups such as, for example, nonylphenol, etc. Suitable epoxides can include, for example, ethylene oxide, propylene oxide, butylene oxide, styrene oxide, etc. and mixtures thereof. The epoxides can be polymerized with the low equivalent weight monofunctional starters using well-known techniques and a variety of catalysts, including alkali metals, alkali metal hydroxides and alkoxides, double metal cyanide complexes, and many more. Suitable monofunctional starters include those monols described in, for example, U.S. Pat. Nos. 6,391,935 and 6,821,308, the disclosures of which are hereby incorporated by reference. Suitable polyoxyalkylene monols to be used as the starter for (a) may contain up to 20% by weight, based on 100% by weight of the polyoxyalkylene monol, of copolymerized oxyethylene.

The monol initiated oxyalkylene ether (a) may also be characterized in one embodiment as containing up to 20% by weight of copolymerized oxyethylene, based on the total weight of the monol initiated oxyalkylene ether (a). This weight percentage includes the initiator or starter and all of the added epoxide(s). These monol initiated oxyalkylene ethers (a) may contain less than or equal to 20% by weight, or less than or equal to 15% by weight, or less than or equal to 10% by weight, based on the total weight of the monol initiated oxyalkylene ether (a), of copolymerized oxyethylene. These monol initiated oxyalkylene ethers (a) may also contain more than 0%, or at least 2% or at least 5%, based on the total weight of the monol initiated oxyalkylene ether (a), of copolymerized oxyethylene. The amount of copolymerized oxyethylene present in the monol initiated oxyalkylene ethers (a) may vary between any combination of these upper and lower values, inclusive, such as, more than 0% to less than or equal to 20%, or at least 2% to less than or equal to 15%, or at least 5% to less than or equal to 10% by weight, based on the total weight of the monol initiated oxyalkylene ether (a).

The monol initiated oxyalkylene ethers (a) can have virtually any desired arrangement of oxyalkylene units with the proviso that these contain less than or equal to 20% of copolymerized oxyethylene, based on the total weight of the monol initiated oxyalkylene ether (a). This weight percentage includes the initiator or starter and all of the added epoxide(s). Some examples of suitable monol initiated oxyalkylene ethers (a) include PO homopolymers, block EO-PO copolymers, random EO/PO copolymers, PO polymers that are “tipped” with EO or with a mixture of EO and PO are possible. These “tipped” PO polymers should use a mixture of EO and PO to achieve a particular oxyethylene content and/or a desired primary hydroxyl content, or any other desired configuration. The so-called PO homopolymers are suitable with the proviso that they satisfy the above described amounts of copolymerized oxyethylene. The epoxides can be polymerized using well known techniques and a variety of catalysts, including alkali metals, alkali metal hydroxides and alkoxides, double metal cyanide complexes and many more.

In one embodiment, the monol initiated oxyalkylene ether (a) comprises an oxypropylene block next to the low equivalent weight monofunctional starter followed by a mixed oxypropylene and oxyethylene block at the end of the chain. In another embodiment, the oxyalkylene block at the end of the chain comprises copolymerized oxypropylene and copolymerized oxyethylene wherein the copolymerized oxyethylene content is 20% by weight or less, based on 100% by weight of the oxyalkylene block.

Suitable polyether polyols for component (b) typically have a hydroxyl number of 47 to 300, and a nominal functionality of 2. These polyether polyols may have hydroxyl numbers of at least 47, or at least 70. The polyether polyols may also have hydroxyl numbers of less than or equal to 300, or of less than or equal to 240. Suitable polyether polyols may also have a hydroxyl number ranging between any combination of these upper and lower values, inclusive, of at least 47 to 300, or of at least 70 to 240. These polyether polyols (b) may be prepared from low equivalent weight starters such as, for example, propylene glycol, dipropylene glycol, ethylene glycol, tripropylene glycol, water, methyl-1,3-propanediol, and the like, and mixtures thereof.

Suitable polyether polyols for component (b) comprise a first oxide block having 20 to 50% by weight of copolymerized oxyethylene, based on the weight of the polyether polyol at the end of the first oxide block, and a second oxide block comprising 10 to 50% by weight of copolymerized oxyethylene, based on the weight of the second oxide block.

The first oxide block of these polyether polyols may comprise at least 20%, or at least 25% of copolymerized oxyethylene, based on the weight of the polyether polyol at the end of the first oxide block. In addition, the first oxide block of these polyether polyols may contain 50% or less, or 45% or less of copolymerized oxyethylene, based on the weight of the polyether polyol at the end of the first oxide block. Thus, the first oxide block of this polyether polyol may comprise any amount of copolymerized oxyethylene between the above disclosed upper and lower values, inclusive, unless otherwise stated, such as at least 20% to 50% by weight or less, or at least 25% to 45% by weight or less (based on the weight of the polyether polyol at the end of the first oxide block).

Once the addition of the first oxide block is complete, the polyether polyol has a hydroxyl number of 100 to 420, a nominal functionality of 2, and containing from 20 to 50% by weight of copolymerized oxyethylene, based on the weight of the polyether polyol at the end of the first oxide block. This first oxide block is formed by the copolymerization of ethylene oxide and propylene oxide in the presence of a low equivalent weight starter having a nominal functionality of 2.

The second oxide block of these polyether polyols may comprise at least 10%, or at least 15%, or at least 20%, of copolymerized oxyethylene, based on the weight of the second oxide block. In addition, the second oxide block of these polyether polyols may contain 50% or less, or 45% or less of copolymerized oxyethylene, based on the weight of the second oxide block. Thus, the second oxide block of this polyether polyol may comprise any amount of copolymerized oxyethylene between the above disclosed upper and lower values, inclusive, unless otherwise stated, such as at least 10% to 50% by weight or less, or at least 15% to 45% by weight or less, or at least 20% to 45% by weight or less (based on the weight of the second oxide block).

These polyether polyols (b) can be block EO-PO copolymers, EO-capped polyoxypropylenes, random EO/PO copolymers, PO polymers that are “tipped” with a mixture of EO and PO to achieve the desired amount of copolymerized oxyethylene and/or a particular primary hydroxyl content, random EO/PO copolymers that vary the ratio of EO to PO along the chain to provide EO rich end groups or PO rich end groups or any other desired configuration. The epoxides can be polymerized using well-known techniques and a variety of catalysts, including alkali metals, alkali metal hydroxides and alkoxides, double metal cyanide complexes, and many more.

Suitable polyether polyols for component (c) typically have a hydroxyl number of 47 to 300, a nominal functionality of greater than 2 to 8. These polyether polyols may also have hydroxyl numbers of at least 47, or at least 70. The polyether polyols may also have hydroxyl numbers of less than or equal to 300, or of less than or equal to 240. Suitable polyether polyols may also have a hydroxyl number ranging between any combination of these upper and lower values, inclusive, of at least 47 to 300, or at least 70 to 240. The polyether polyols may also have a nominal functionality of greater than 2, or of at least 3. The nominal functionality of the polyether polyols may also be less than or equal to 8, or less than or equal to 6. Suitable polyether polyols may have a nominal functionality ranging between any combination of these upper and lower values, inclusive, such as greater than 2 to 8, or at least 3 to 6. These polyether polyols (c) may be prepared from low equivalent weight starters such as, for example, glycerin, trimethylolpropane, pentaerythritol, sucrose, sorbitol, and the like, and mixtures thereof.

Suitable polyether polyols for component (c) comprise a first oxide block having 20 to 50% by weight of copolymerized oxyethylene, based on the weight of the polyether polyol at the end of the first oxide block, and a second oxide block comprising 10 to 50% by weight of copolymerized oxyethylene, based on the weight of the second block.

The first oxide block of these polyether polyols may comprise at least 20%, or at least 25% of copolymerized oxyethylene, based on the weight of the polyether polyol at the end of the first oxide block. In addition, the first oxide block of these polyether polyols may contain 50% or less, or 45% or less of copolymerized oxyethylene, based on the weight of the polyether polyol at the end of the first oxide block. Thus, the first oxide block of this polyether polyol may comprise any amount of copolymerized oxyethylene between the above disclosed upper and lower values, inclusive, unless otherwise stated, such as at least 20% to 50% by weight or less, or at least 25% to 45% by weight or less (based on the weight of the polyether polyol at the end of the first oxide block).

Once the addition of the first oxide block of is complete, the polyether polyol has a hydroxyl number of 100 to 420, a nominal functionality of greater than 2 to 8, and containing from 20 to 50% by weight of copolymerized oxyethylene, based on the weight of the polyether polyol at the end of the first oxide block. This first oxide block is formed by the copolymerization of ethylene oxide and propylene oxide in the presence of a low equivalent weight starter having a nominal functionality of greater than 2 to 8.

The second oxide block of these polyether polyols may comprise at least 10%, or at least 15%, or at least 20%, of copolymerized oxyethylene, based on the weight of the second oxide block. In addition, the second oxide block of these polyether polyols may contain 50% or less, or 45% or less of copolymerized oxyethylene, based on the weight of the second oxide block. Thus, the second oxide block of this polyether polyol may comprise any amount of copolymerized oxyethylene between the above disclosed upper and lower values, inclusive, unless otherwise stated, such as at least 10% to 50% by weight or less, or at least 15% to 45% by weight or less, or at least 20% to 45% by weight or less (all based on the weight of the second oxide block).

These polyether polyols (c) can be block EO-PO copolymers, EO-capped polyoxypropylenes, random EO/PO copolymers, PO polymers that are “tipped” with a mixture of EO and PO to achieve the desired amount of copolymerized oxyethylene and/or a particular primary hydroxyl content, random EO/PO copolymers that vary the ratio of EO to PO along the chain to provide EO rich end groups or PO rich end groups or any other desired configuration. The epoxides can be polymerized using well-known techniques and a variety of catalysts, including alkali metals, alkali metal hydroxides and alkoxides, double metal cyanide complexes, and many more.

In accordance with the invention, individual components, i.e. the monol initiated oxyalkylene ether (a), the polyether polyol (b) and the polyether polyol (c), of the novel polyether polyol blends described herein can be made individually using alkoxylation techniques which are well known in the literature and then blended together to form the novel polyether polyol blend, or they can be made using the novel in-situ process described herein.

These novel polyether polyol blends comprise (i) from 20% to 50% by weight, or from 25% to 40% by weight of (a) the monol initiated oxyalkylene ether, and (ii) from 80 to 50% by weight, or from 75% to 60% of polyether polyols (b) and (c); wherein (ii) the 80 to 50% by weight (or 75 to 60% by weight) of polyether polyols (b) and (c) comprises polyether polyol (b) in an amount of 10 to 90% by weight (or 30 to 70% by weight) and polyether polyol (c) in an amount of 90 to 10% by weight (or 70 to 30% by weight).

The process for preparing the novel polyether polyol blends having an overall functionality of greater than 2, an overall hydroxyl number of 56 mg KOH/g to 140 mg KOH/g, and having an overall content of copolymerized oxyethylene of from 20 to 40% by weight, comprises blending: (a) a monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a), (b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block, and (c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block; wherein the novel polyether polyol blend comprises (i) 20 to 50% by weight of (a) the monol initiated oxyalkylene ether and (ii) 80 to 50% by weight of polyether polyols (b) and (c), with the sum of the %' s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.

The process of preparing the novel in-situ formed polyether polyol blends having an overall hydroxyl number of 56 mg KOH/g to 140 mg KOH/g, an overall functionality greater than 2, and an overall content of copolymerized oxyethylene of 20% to 40% by weight, comprises:
I) introducing into a reaction vessel a mixture comprising:
   (1) an initially charged starter (Sᵢ) comprising a monofunctional compound having a hydroxyl number of less than or equal to 80,
and
   (2) a DMC (double metal cyanide) catalyst;
II) feeding
   (1) an epoxide comprising propylene oxide and ethylene oxide in a weight ratio of 100:0 to 80:20,
into the reaction vessel;
III) allowing the epoxide mixture and the initially charged starter (Sᵢ) to react and to polymerize by feeding the epoxide until the equivalent weight of the monofunctional compound is increased by at least 10% by weight and reaches a value between 1,500 and 6,000;
IV) feeding
   (1) an epoxide comprising propylene oxide and ethylene oxide in a weight ratio of 78:22 to 45:55;
   while continuously adding
   (2) a low equivalent weight continuously added starter (S_{c}) having a nominal functionality of greater than 2 to 6, and an equivalent weight of 28 to 400,
   into the reaction vessel while continuing to feed epoxide;
V) completing addition of the low equivalent weight continuously added starter (S_{c});
VI) feeding
   (1) an epoxide comprising propylene oxide and ethylene oxide fed at the same ratio as IV)(1) to fully react all the low equivalent weight continuously added starter (S_{c});
VII) allowing the mixture to continue to polymerize in the reaction vessel thereby forming
   (1) a polyether polyol with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1);
VIII) feeding
   (1) an epoxide comprising propylene oxide and ethylene oxide;
IX) allowing the mixture to continue to polymerize in the reaction vessel thereby forming
   (1) a polyether polyol with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1), and a second oxide block comprising 10 to 50% by weight of copolymerized oxyethylene, based on the weight of epoxide added in VIII)(1);
X) thereby forming
   (1) a novel in-situ formed polyether polyol blend which has an overall hydroxyl number of 56 mg KOH/g to 140 mg KOH/g, an overall functionality of greater than 2, and an overall content of copolymerized oxyethylene of 20% to 40% by weight, and which comprises
      (a) a monol initiated oxyalkylene ether having a hydroxyl number of less than or equal to 56, and containing less than or equal to 20% by weight of copolymerized oxyethylene, based on 100% by weight of (a),
      (b) a polyether polyol having a hydroxyl number of 47 to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10% to 50% by weight of copolymerized oxyethylene, based on the weight of the second oxide block,
      and
      (c) a polyether polyol having a hydroxyl number of 47 to 300 mg KOH/g, and a nominal functionality of greater than 2 to 8, with the polyether polyol comprising a first oxide block having 20% to 50% by weight of copolymerized oxyethylene, based on the weight of the polyether polyol at the end of the first oxide block, and a second oxide block comprising 10 to 50% by weight of copolymerized oxyethylene, based on the weight of the second oxide block;
wherein the novel in-situ formed polyether polyol blend comprises (i) 20% to 50% by weight of (a) the monol initiated oxyalkylene ether, and (ii) 80 to 50% by weight of polyether polyols (b) and (c), with the sum of the %' s by weight totaling 100% by weight of the novel in-situ formed polyether polyol blend, and wherein (ii) the 80 to 50% by weight of polyether polyols (b) and (c) comprises polyether polyol (b) in an amount of from 10 to 90% by weight and polyether polyol (c) in an amount of 90 to 10% by weight.

In one embodiment, step VII) forms (1) from 2 to 4 polyether polyols, preferably 2 polyether polyols, with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2) and of epoxide added in VI)(1); and/or step IX) forms (1) from 2 to 4 polyether polyols, preferably 2 polyether polyols, with a first alkylene oxide block added to the low equivalent weight continuously added starter (S_{c}) having 20 to 50% by weight of the amounts of epoxide added in IV)(1), of low equivalent weight continuously added starter (S_{c}) added in IV)(2), and of epoxide added in VI)(1), and a second oxide block comprising 10 to 50% by weight of copolymerized oxyethylene, based on the weight of epoxide added in VIII)(1).

In general, any epoxide polymerizable using DMC catalysis can be used in the novel polyether polyol blend comprising a monol initiated oxyalkylene ether (a) and the two polyether polyols (b) and (c). Suitable epoxides include ethylene oxide, propylene oxide, butylene oxides (e.g., 1,2-butylene oxide, isobutylene oxide), styrene oxide, and the like, and mixtures thereof. Polymerization of epoxides using DMC catalysts and hydroxyl-containing starters results in polyether polyols, as is well understood in the art.

Other monomers that will copolymerize with an epoxide in the presence of a DMC catalyst may be included in the process of the invention to make other types of epoxide polymers. Some examples include epoxides copolymerize with oxetanes as described in U.S. Pat. No. 3,404,109, the disclosure of which is herein incorporated by reference, to give polyethers, or with anhydrides to give polyesters or polyetheresters as described in U.S. Pat. Nos. 5,145,883 and 3,538,043, the disclosures of which are herein incorporated by reference, or with carbon dioxide to form polyether carbonate polyols such as those described in U.S. Pat. Nos. 4,826,887, 4,826,952, 4,826,953, 6,713,599, 7,977,501, 8,134,022, 8,324,419, 8,946,466 and 9,249,259, the disclosures of which are herein incorporated by reference, and U.S. Published Patent Application 2015/0232606.

In accordance with this process, an initially charged starter (Sᵢ) is used, and the initially charged starter (Sᵢ) is different than the continuously added starter (S_{c}). The initially charged starter (Sᵢ) is comprised of, either totally or in large part, a compound having one active hydrogen per molecule that can serve as a site for epoxide addition, and having a hydroxyl number of less than or equal to 80, or of less than or equal to 56. The suitable starters for the initially charged starter (Sᵢ) are the same monofunctional starters described above as suitable starters for the monol initiated oxyalkylene ether (a). These are formed by addition of multiple equivalents of epoxide to a low equivalent weight monofunctional starter such as, for example, methanol, ethanol, phenols, allyl alcohol, butyl carbitol, longer chain alcohols, etc., and mixtures thereof. Examples of suitable longer chain alcohols include C₁₀, C₁₂, C₁₃, C₁₄ and/or C₁₅ monols, which may be used individually or as mixtures. Suitable monoethers include a hydrocarbyl residue (Z) in which the hydrocarbyl residue is a C₄-C₆₀, and preferably a C₉-C₃₀ alkyl, aryl or aralkyl group. The hydrocarbyl residue is typically derived from a monohydroxyl compound such as an alcohol or a phenol. Also suitable are monoethers derived from phenols substituted with C₄-C₁₅ alkyl groups such as, for example, nonylphenol, etc. Suitable epoxides can include, for example, ethylene oxide, propylene oxide, butylene oxide, styrene oxide, etc. and mixtures thereof. The epoxides can be polymerized using well-known techniques and a variety of catalysts, including alkali metals, alkali metal hydroxides and alkoxides, double metal cyanide complexes, and many more. Suitable initially charged monofunctional starters (Sᵢ) can also be made, for example, by first producing a diol or triol and then converting all but one of the remaining hydroxyl groups to an ether, an ester or other non-reactive group.

One suitable class of polyether monol starters or initially charged starters (Sᵢ) includes polyoxypropylene monols having a hydroxyl number of less than or equal to 80, or of less than or equal to 56 mg KOH/g. These compounds facilitate DMC catalyzed addition of epoxide and provide suitable build ratios for the production of the novel in-situ formed polyether polyol blends herein. The polyoxypropylene monols used as the initially charged starter (Sᵢ) can be made using processes well known to the skilled artisan including processes defined in U.S. Pat. Nos. 5,689,012, 5,177,777, 10,723,829, 10,723,830 and 10,738,155, the disclosures of which are herein incorporated by reference.

In the process of the present invention, the quantity of an initially charged starter (Sᵢ) used depends on many factors, including, for example, the reactor dimensions, the identity of the initially charged starter (Sᵢ), the equivalent weights of the initially charged starter (Sᵢ) and of the target product, the equivalent weight of the continuously added starter (S_{c}), and other factors.

Any DMC catalyst known in the art is suitable for use in the process of the present invention. These well-known catalysts are the reaction products of a water-soluble metal salt (e.g., zinc chloride) and a water-soluble metal cyanide salt (e.g., potassium hexacyanocobaltate). Preparation of suitable DMC catalysts is described in many references, including, for example, U.S. Pat. Nos. 5,158,922, 4,477,589, 3,427,334, 3,941,849, 5,470,813, and 5,482,908, the disclosures of which are incorporated herein by reference. One suitable type of DMC catalyst is zinc hexacyanocobaltate.

The DMC catalyst includes an organic complexing agent. As disclosed in the preceding references, the complexing agent is needed for an active catalyst. Suitable complexing agents are water-soluble heteroatom-containing organic compounds that can complex with the DMC compound, as well as water-soluble aliphatic alcohols. An example of a suitable aliphatic alcohol is tert-butyl alcohol. The DMC catalyst may include, in addition to the organic complexing agent, a polyether, as is described in U.S. Pat. No. 5,482,908, the disclosure of which is herein incorporated by reference.

Suitable DMC catalysts for use in the process are highly active catalysts such as those described in U.S. Pat. Nos. 5,482,908 and 5,470,813, the disclosures of which are herein incorporated by reference. High activity allows the catalysts to be used at very low concentrations, and possibly at concentrations which are low enough to overcome any need to remove the catalyst from the finished blends of the novel in-situ formed polyether polyol blends.

The process of the invention also requires a continuously added starter (S_{c}) as described in detail herein. Conventional processes for making polyether polyols, including KOH-catalyzed and DMC-catalyzed processes, charges the catalyst and all the starter to be used to the reactor at the start of the polymerization, and then adds the epoxide continuously. In the process of forming a novel in-situ formed polyether polyol blend suitable for the invention, the DMC catalyst and an initial monofunctional starter (or initially charged starter) (Sᵢ) are charged to the reactor followed by epoxide feed and polymerization until the monol reaches the desired equivalent weight. At this point, a feed (i.e. as described in step IV)(2) above) of continuously added starter (S_{c}) is begun and it proceeds at a continuous controlled rate relative to the continuing epoxide feed until the addition of the feed of continuously added starter (S_{c}) is completed. Epoxide feed is continued until the desired hydroxyl number of the feed of continuously added starter (S_{c}) components is reached. The continuously added starter (S_{c}) may be mixed with the epoxide and added to the reactor, or it may be added to the reactor as a separate stream. It is also possible that DMC catalyst can be added continuously with the continuously added starter (S_{c}). The epoxide fed continuously with the continuously added starter (S_{c}) (as described in IV)(1) above) has a different epoxide composition (i.e., propylene oxide to ethylene oxide) than that which is fed during the polymerization of the initially charged starter (Sᵢ). In the process of the present invention to form a novel in-situ formed polyether polyol blend, a second block (i.e. as described in step VIII)(1) above) of epoxide is started after completion of the first epoxide block. The second block of epoxide is completed at a propylene oxide to ethylene oxide ratio that is the same as was used for the first block of epoxide, or it can be a different ratio. The selection of the type and number of compounds used as the continuously added starter (S_{c}) determines the type and number of polyether polyols formed in step X) above (i.e. polyether polyols formed in X)(1)(b) and X)(1)(c), etc.). The skilled artisan knows and understands that the lowest equivalent weight substance preferably reacts with alkylene oxide in the presence of DMC catalyst, hence the continuously added starter (S_{c}) will preferentially react with the alkylene oxide present. This is commonly known and referred to by one of ordinary skill in the art as “catch up kinetics”. This allows the in-situ production of different components of the novel polyether polyol blend while only minimally affecting the other, higher equivalent weight components. Catch up kinetics is described in “Chemistry and Technology of Polyols for Polyurethanes”, 2^{nd} Edition, Volume 1, 2016, M. Ionescu, pages 189-190, the disclosure of which is herein incorporated by reference.

The continuously added starter (S_{c}) is typically a low equivalent weight starter or polyol or a blend of low equivalent weight starters or polyols. Low equivalent weight polyols as defined in this application having from 2 hydroxyl groups to 8 hydroxyl groups. It also may be beneficial to add more than one continuously added starter (S_{c}) having different functionalities either simultaneously or sequentially. The functionality of the continuously added starter (S_{c}) or multiple continuously added starters (S_{c}) should be chosen such that the average functionality of the resultant polyether polyol is from 2 to 6, or from 2 to 3. These low equivalent weight polyols may have at least 2 hydroxyl groups. These low equivalent weight polyols may also have 8 hydroxyl groups or less, or 6 hydroxyl groups or less, or 3 hydroxyl groups or less. The low equivalent weight polyols used for the continuously added starter (S_{c}) may contain any number of hydroxyl groups which ranges between any combination of these upper and lower values, inclusive, such as from at least 2 hydroxyl groups to 8 hydroxyl groups or less, or 2 hydroxyl groups to 6 hydroxyl groups, or 2 hydroxyl groups to 3 hydroxyl groups.

Suitable low equivalent weight polyols for the continuously added starter (S_{c}) for the intermediate of the polyether polyols (b) have a nominal functionality of 2, and an equivalent weight of 28 to 400. Suitable low equivalent weight polyols for the intermediate of the polyether polyols (c) have a nominal functionality of greater than 2 to 8, and an equivalent weight of 28 to 400.

Examples of suitable low equivalent weight polyols to be used as the continuously added starter (S_{c}) include compounds such as, for example, glycerin, propylene glycol, dipropylene glycol, ethylene glycol, trimethylolpropane, sucrose, sorbitol, tripropylene glycol, and the like, and mixtures thereof. In one embodiment, the continuously added starter (S_{c}) comprises propylene glycol and glycerin. Low equivalent weight polyether polyols prepared by multiple epoxide addition to these polyols or other starters with two or more active hydrogens may also be employed as the continuously added starter (S_{c}).

The continuously added starter (S_{c}) can also be other compounds having at least two active hydrogens per molecule, which are known to be suitable initiators for conventional DMC-catalyzed epoxide polymerizations, including compounds such as, for example, alcohols, thiols, aldehydes and ketones containing enolizable hydrogens, malonic esters, phenols, carboxylic acids and anhydrides, aromatic amines, acetylenes, and the like, and mixtures thereof. Examples of suitable active hydrogen-containing compounds appear in U.S. Pat. Nos. 3,900,518, 3,941,849, and 4,472,560, the disclosures of which are incorporated herein by reference.

As described previously, a wide variety of epoxides can be employed in the current process. Propylene oxide and ethylene oxide are the most commonly used epoxides. A unique feature of the current process is that the compositions of the epoxide can be varied to control the composition of the monol initiated oxyalkylene ether (a), polyether polyol (b), and polyether polyol (c) in the final product. For example in the in-situ production of the novel polyether polyol blends, propylene oxide can be added alone during polymerization of the monol initiated oxyalkylene ether (a), prior to the start of the addition of the continuously added starter (S_{c}). After the feed of continuously added starter (S_{c}) is started, a blend of ethylene oxide and propylene oxide can be fed to yield a high functionality polyether polyol comprised of a poly(oxyethylene-oxypropylene) copolymer. Because oxide addition via DMC catalysis occurs predominantly on the lower equivalent weight polyether polyol, the monol initiated oxyalkylene ether component can remain largely poly(oxypropylene). By reversing these sequences, the monol initiated oxyalkylene ether could be produced with higher poly(oxyethylene) content and the polyether polyol (from the feed of continuously added starter (S_{c})) could be predominantly poly(oxypropylene).

The epoxide composition may also be varied during the initial polymerization of the monol initiated oxyalkylene ether and/or at some point during and/or after the addition of the continuously added starter (S_{c}). This provides flexibility for controlling the distribution of oxyethylene or oxypropylene within the monol initiated oxyalkylene ether and polyether polyols and allows some control of the primary versus secondary hydroxyl content of the monol initiated oxyalkylene ether and polyether polyols, and thus, the relative reactivity of the constituents in the final polyether polyol composition. In this way, it is possible to design the product to meet the reactivity and performance requirements of the intended applications such as viscoelastic polyurethane foams.

In the process of the present invention, the propylene oxide to ethylene oxide composition fed during the first oxide block of step IV)(1) above ranges from 78:22 to 45:55 weight % based on the total epoxide fed during the first oxide block. The propylene oxide to ethylene oxide composition fed during the second oxide block of step VIII)(1) above ranges from 90:10 to 50:50 weight % based on the total epoxide fed during the second oxide block.

The total alkylene oxide addition time can range from 30 minutes to 12 hours depending on the mixing of the reaction system and the heat removal capability of the reaction system. The alkylene oxide feed rates can remain constant during the feeding of alkylene oxide or one or more of the alkylene oxide feed rates can vary during the course of the alkylene oxide feed to provide improved reaction conditions (i.e., mixing, heat removal, etc) or improved product quality or optimized composition (i.e., increased EO composition by increasing the EO feed rate and decreasing or holding constant the PO feed rate).

In one embodiment, the novel polyether polyol blends herein and the novel in-situ formed polyether polyol blends herein are free of a polyether polyol having an OH number of 20 to 240, an average functionality of 2 to 8, and containing at least 50% by weight of copolymerized oxyethylene, based on 100% by weight of the polyether polyol.

The process for the production of a viscoelastic polyurethane foam comprises reacting (A) toluene diisocyanate, with (B) an isocyanate-reactive component comprising (1) the novel polyether polyol blends having an overall functionality of greater than 2, an overall hydroxyl number of 56 mg KOH/g to 140 mg KOH/g, and having an overall content of copolymerized oxyethylene of from 20% to 40% by weight, as described herein, in the presence of (C) a blowing agent, (D) a catalyst, and (E) a surfactant.

Component (A) comprises toluene diisocyanate. Any mixture of isomers of toluene diisocyanate is suitable, with a mixture comprising 65% to 100% (or 80%) of the 2,4-isomer and 0% to 35% (or 20%) of the 2,6-isomer being preferred. In one embodiment, toluene diisocyanate comprising 80% of the 2,4-isomer and 20% of the 2,6 isomer is used.

The isocyanate-reactive component (B) comprises the novel polyether polyol blend (1) described herein which has an overall hydroxyl number of 56 mg KOH/g to 140 mg KOH/g, an overall functionality of greater than 2, and having an overall hydroxyl content of copolymerized oxyethylene of from 20% to 40% by weight. This novel polyether polyol blend may have a hydroxyl number of at least 56, or at least 80. This novel polyether polyol blend may also have a hydroxyl number of less than or equal to 140, or less than or equal to 120. These novel polyether polyol blends may have a hydroxyl number ranging between any combination of these upper and lower values, inclusive, such as at least 56 to less than or equal to 140, or at least 80 to 120 or less.

In the isocyanate-reactive component (B), the novel polyether polyol blend (1) also typically has an overall functionality of greater than 2. The overall functionality of this novel polyether polyol blend may also be 3 or less. The novel polyether polyol blend (1) may have an overall functionality ranging between any combination of these upper and lower values, inclusive, such as greater than 2, or greater than 2 to 3.

The composition of the novel polyether polyol blend (1) is as described hereinabove. The suitable novel polyether polyol blends may either be formed in-situ or by blending the individual components.

In addition to the novel polyether polyol blend (1), the isocyanate-reactive component (B) for the viscoelastic flexible polyurethane foams and process of preparing the viscoelastic flexible foams may additionally comprise a conventional polyether polyol, a polyester polyol, a polyether carbonate polyol, a polyetherester polyol, polymer polyols, polythioethers, polyacetals, polycarbonates, etc., as well as various low equivalent weight chain extenders and/or crosslinking agents, both of which may contain hydroxyl groups and/or amine groups capable of reacting with the isocyanate groups of the isocyanate component.

In addition, in the process of preparing the viscoelastic flexible polyurethane foam, the isocyanate-reactive component (B) which comprises (1) the novel polyether polyol blend described above is free of a polyether polyol having an OH number of 20 to 240, an average functionality of 2 to 8, and containing at least 50% by weight of copolymerized oxyethylene, based on 100% by weight of the polyether polyol.

In one embodiment, a foam modifier or foam processing aid is added to the formulation to enhance processing and help stabilize the viscoelastic flexible foam against cold flow and/or dishing by providing dimensional stability against deformation and reduced settling of the viscoelastic flexible foam. These processing aids or modifiers are typically chain extenders and/or cross-linking agents.

In addition, the foam modifiers or processing aids may have a hydroxyl number of at least 300, or of at least 600.

Suitable blowing agents (C) for the present invention include, for example chemical blowing agents, i.e. isocyanate reactive agents that generate blowing gases, such as for example water and formic acid and physical blowing agents such as acetone, carbon dioxide, chlorofluorocarbons, highly fluorinated and/or perfluorinated hydrocarbons, chlorinated hydrocarbons, aliphatic and/or cycloaliphatic hydrocarbons such as propane, butane, pentane, hexane, etc., or acetals such as methylal. These physical blowing agents are usually added to the polyol component of the system. However, they can also be added in the isocyanate component or as a combination of both the polyol component and the isocyanate component. It is also possible to use them together with highly fluorinated and/or perfluorinated hydrocarbons, in the form of an emulsion of the polyol component. If emulsifiers are used, they are usually oligomeric acrylates which contain polyoxyalkylene and fluoroalkane radicals bonded as side groups and have a fluorine content of 5 to 30% by weight. Such products are sufficiently well known from plastics chemistry, and are described in U.S. Pat. No. 4,972,002, the disclosure of which is herein incorporated by reference.

The amount of blowing agent or blowing agent mixture used may range from 0.5 to 20% by weight, based on 100% by weight of (B) the isocyanate-reactive component. As used herein with respect to the amount of blowing agent, the isocyanate-reactive component includes (1) the novel polyether polyol blend described herein. In some instances, the amount of blowing agent present may be at least 0.5% or at least 0.75% by weight, based on 100% by weight of component (B). The amount of blowing agent present may also be 20% or less, or 10% by weight or less, based on 100% by weight of component (B). The blowing agent may be present in any amount ranging between any combination of these upper and lower above values, inclusive, such as at least 0.5% to 20% or less, or at least 0.75% to 10% by weight or less, based on 100% by weight of component (B).

When water is the blowing agent, the amount of water typically present can range from at least 0.5 to 10%, based on 100% by weight of component (B) the isocyanate-reactive component. In some instances, the amount of blowing agent present may be at least 0.5% or at least 0.75% by weight, based on 100% by weight of component (B). The amount of water present as a blowing agent may also be 10% or less, or 7% by weight or less, based on 100% by weight of component (B). The blowing agent may be present in any amount ranging between any combination of these upper and lower values, inclusive, such as at least 0.5% to 10% or less, or at least 0.75% to 7% by weight or less, based on 100% by weight of component (B). The addition of water can be effected in combination with the use of the other blowing agents described. In accordance with the present invention, water is the preferred blowing agent. Also, preferred is the use of water along with pressurized carbon dioxide that is dispersed in the polyol or resin blend and frothed by passing through a pressure let down device such as employed for example in the Henecke Novaflex, CarDio (Cannon Viking Limited) and Beamech (CO₂) machines, which are known by those skilled in the art.

The viscoelastic flexible foam is produced in the presence of a surfactant, which helps to stabilize the viscoelastic flexible foam until it cures. Suitable surfactants are those well known in the polyurethane industry. A wide variety of organosilicone surfactants are commercially available. Examples of suitable surfactants are Niax L-620 surfactant, a product of Momentive Performance Materials, and Tegostab B8244, a product of Evonik-Goldschmidt. Many other silicone surfactants known to those in the art may be substituted for these suitable silicones. The surfactant is typically used in an amount within the range of at least 0.1 to 4 parts, based on 100% by weight of component (B). The surfactant may be present in amounts ranging from at least 0.1, or at least 0.2 parts, based on 100% by weight of component (B).

The surfactant may be also present in amounts ranging from 4 parts or less, or 3 parts or less, based on 100% by weight of component (B). The amount of surfactant may range between any combination of these upper and lower values, inclusive, such as at least 0.1 to 4 parts, or at least 0.2 to 3 parts, based on 100% by weight of component (B).

At least one polyurethane catalyst is required to catalyze the reactions of the isocyanate-reactive components and water with the polyisocyanate. It is common to use both an organoamine and an organotin compound for this purpose. Suitable polyurethane catalysts are well known in the art; an extensive list appears in U.S. Pat. No. 5,011,908, the disclosure of which is herein incorporated by reference. Suitable organotin catalysts include tin salts and dialkyltin salts of carboxylic acids. Examples include stannous octoate, dibutyltin dilaurate, dibutyltin diacetate, stannous oleate, and the like. Stannous octoate is particularly preferred. Preferred organoamine catalysts are tertiary amines such as trimethylamine, triethylamine, triethylenediamine, bis(2,2′-dimethyl-amino)ethyl ether, N-ethylmorpholine, diethylenetriamine, and the like.

The polyurethane catalysts are typically used in an amount within the range of 0.01 to 3 parts, based on 100% by weight of component (B). The polyurethane catalysts may be present in amounts of at least 0.01, or at least 0.1 parts, based on 100% by weight of component (B). The polyurethane catalysts may be present in amounts of 3 parts or less, or 2 parts or less based on 100% by weight of component (B). The polyurethane catalysts may be present in any amount ranging between any combination of these upper and lower values, inclusive, such as at least 0.01 to 3 parts, or at least 0.1 to 2 parts, based on 100% by weight of component (B).

Flame retardants, antioxidants, pigments, dyes, liquid and solid fillers, and many other commercial additives can also be included in the viscoelastic flexible foams in conventional amounts.

The viscoelastic foams of the invention comprise the reaction product of (A) a diisocyanate and/or a polyisocyanate component, with (B) an isocyanate-reactive component comprising (1) the novel polyether polyol blend described herein, in the presence of (C) a blowing agent, (D) a catalyst, and (E) a surfactant. Suitable components for these foams are as described hereinabove.

The viscoelastic flexible foams are prepared using methods that are well known in the industry. These methods may include continuous or discontinuous free-rise slabstock foam processes and molded foam processes. In a typical slabstock process, the isocyanate is continuously mixed together with the other formulation chemicals by passing through a mixing head and then into a trough which overflows onto a moving conveyor.

Alternatively, the reacting mixture is deposited directly onto the moving conveyor. In another embodiment, high pressure liquid carbon dioxide is fed into one or more of the formulation components, typically the polyol, entering into the mixing head and the resin blend is passed through a frothing device where the pressure is let down and the resultant froth is deposited onto the conveyor. The viscoelastic flexible foam expands and rises as it moves down the conveyor to form a continuous foam slab that is cut into blocks or buns of the desired length for curing and storage. After curing for one or more days, these foam buns can be cut into the desired shapes for the end-use applications. In the discontinuous process, the reactants are quickly mixed together through a head or in a large mixing chamber. The reaction mixture is then deposited into a large box or other suitable container where foam expansion occurs to form a bun of the lateral dimensions of the container.

A typical molded viscoelastic flexible foam process usually employs a one-shot approach in which a specific amount of the isocyanate stream (the “A” side) is rapidly combined and mixed with a specific amount of the remaining formulation components (the “B” side). An additional stream may be employed to bring in one or more specific components not included with the “B” side stream. The mixture is quickly deposited into a mold that is then closed. The viscoelastic flexible foam expands to fill the mold and produce a part with the shape and dimensions of the mold.

Although less preferred, an isocyanate-terminated prepolymer approach to making the viscoelastic flexible foams can also be used. In this approach, a significant portion of the isocyanate-reactive mixture is reacted with the polyisocyanate, and the resulting isocyanate-terminated prepolymer is then reacted with the remaining components.

As used and referred to throughout the specification, air flow was measured in accordance with the NOPCO test procedure described by R. E. Jones and G. Fesman, “Journal of Cellular Plastics,” January, 1965, Vol. No. 1, pp. 200-216, the disclosure of which is herein incorporated by reference, using a Amscor Model 1377 automated foam porosity tester. A 2 inch×2 inch×1 inch piece of foam was cut from near the center of the test specimens which itself was cut from the foam blocks after production. Air flow, expressed as standard cubic feet per minute (i.e. scfpm), was measured through the 1 inch thickness at a pressure differential of 0.5 inches of water less than atmospheric pressure. The air flow was in the direction of rise of the foam.

The test used to define foam recovery rate from deformation is the 95% height recovery time as described in ASTM D3574-17. A recovery rate of less than 3 seconds, indicates a fast recovering foam such as observed for resilient foam types. A recovery rate of greater than or equal to 3 seconds is indicative of a slow recovery foam often referred to as “viscoelastic” or “memory” foam.

Other viscoelastic flexible foam physical properties reported in the examples were measured per the standard procedures described in ASTM D3574-17 having the title “Standard Test Methods for Flexible Cellular Materials—Slab, Bonded, and Molded Urethane Foams”.

Commercial production of viscoelastic flexible foams involves mixing together a suitable polyisocyanate, and an isocyanate-reactive component which comprises the novel polyether polyol blend described above, in the presence of a blowing agent, a surfactant, a catalyst, and optionally, various other compounds which are known in the field of polyurethane chemistry to be suitable for preparing viscoelastic flexible foams.

Various aspects of the subject matter described herein are set out in the following numbered clauses:
Clause 1. A novel polyether polyol blend having an overall hydroxyl number of 56 mg KOH/g to 140 mg KOH/g, an overall functionality of greater than 2, and having an overall content of copolymerized oxyethylene of 20% to 40% by weight, which comprises (a) a monol initiated oxyalkylene ether having a hydroxyl number of less than or equal to 56 mg KOH/g polyol, and containing less than or equal to 20% of copolymerized oxyethylene, based on the total weight of the monol initiated oxyalkylene ether (a); (b) a polyether polyol having a hydroxyl number of 47 mg KOH/g polyol to 300 mg KOH/g polyol, and a nominal functionality of 2, in which the polyether polyol comprises a first oxide block having 20% to 50% of copolymerized oxyethylene, based on the weight of the polyether polyol at the end of the first oxide block, and a second oxide block comprising 10 to 50% by weight of copolymerized oxyethylene, based on the weight of the second oxide block; and (c) a polyether polyol having a hydroxyl number of 47 mg KOH/g polyol to 300 mg KOH/g polyol, and a nominal functionality of greater than 2 to 8, in which the polyether polyol comprises a first oxide block having 20% to 50% by weight of copolymerized oxyethylene, based on the weight of the polyether polyol at the end of the first oxide block, and a second oxide block comprising 10% to 50% of copolymerized oxyethylene, based on the weight of the second oxide block; wherein the novel polyether polyol blend comprises (i) 20% to 50% by weight of (a) the monol initiated oxyalkylene ether, and (ii) from 80% to 50% of polyethers (b) and (c), with the sum of the %' s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.
Clause 2. The novel polyether polyol blend of Clause 1 which is formed in-situ.
Clause 3. The novel polyether polyol blend of Clause 1 or Clause 2, wherein the overall hydroxyl number is 80 mg KOH/g to 120 mg KOH/g and the overall functionality is greater than 2 to 3.
Clause 4. The novel polyether polyol blend of one of Clause 1 to Clause 3, wherein (a) the monol initiated oxyalkylene ether has a hydroxyl number of less than or equal to 28 mg KOH/g and contains from 2 to 15% by weight of copolymerized oxyethylene, based on the total weight of the monol initiated oxyalkylene ether (a).
Clause 5. The novel polyether polyol blend of one of Clause 1 to Clause 4, wherein (a) the monol initiated oxyalkylene ether contains at least 5% to less than or equal to 10% by weight of copolymerized oxyethylene, based on the total weight of the monol initiated oxyalkylene ether (a).
Clause 6. The novel polyether polyol blend of one of Clause 1 to Clause 5, wherein (b) said polyether polyol has a hydroxyl number of 70 to 240 mg KOH/g, and comprises 25% to 45% by weight of copolymerized oxyethylene in the first oxide block based on the weight of the polyether polyol at the end of the first oxide block, and 15% to 45% by weight of copolymerized oxyethylene in the second oxide block based on the weight of the second oxide block.
Clause 7. The novel polyether polyol blend of one of Clause 1 to Clause 6, wherein (c) said polyether polyol has a hydroxyl number of 70 to 240 mg KOH/g, a nominal functionality of 3 to 6, and comprises 25% to 45% by weight of copolymerized oxyethylene in the first oxide block based on the weight of the polyether polyol at the end of the first oxide block, and 15% to 45% by weight of copolymerized oxyethylene in the second oxide block based on the weight of the second oxide block.
Clause 8. The novel polyether polyol blend of one of Clause 1 to Clause 7, wherein the first oxide block of (b) said polyether polyol is formed by the copolymerization of ethylene oxide and propylene oxide in the presence of a low equivalent weight starter having a nominal functionality of 2.
Clause 9. The novel polyether polyol blend of one of Clause 1 to Clause 8, wherein the first oxide block of (c) said polyether polyol is formed by the copolymerization of ethylene oxide and propylene oxide in the presence of a low equivalent weight starter having a nominal functionality of greater than 2 to 8.
Clause 10. The novel polyether polyol blend of one of Clause 1 to Clause 9, wherein the polyether polyol (b) has a hydroxyl number of 100 to 420 once the addition of the first oxide block is complete, a nominal functionality of 2, and contains from 20 to 50% by weight of copolymerized oxyethylene, based on the weight of the polyether polyol at the end of the first oxide block.
Clause 11. The novel polyether polyol blend of one of Clause 1 to Clause 10, wherein the polyether polyol (c) has a hydroxyl number of 100 to 420 once the addition of the first oxide block is complete, a nominal functionality of greater than 2 to 8, and contains from 20 to 50% by weight of copolymerized oxyethylene, based on the weight of the polyether polyol at the end of the first oxide block.
Clause 12. The novel polyether polyol blend of one of Clause 1 to Clause 11, which comprises (i) from 25 to 40% by weight of (a) said monol initiated oxyalkylene ether, and (ii) from 75 to 60% by weight of polyether polyols (b) and (c), wherein the 75 to 60% by weight of polyether polyols (b) and (c) comprises polyether polyol (b) in an amount of 30 to 70% by weight, and polyether polyol (c) in an amount of 70 to 30% by weight.
Clause 13. The novel polyether polyol blend of one of Clause 1 to Clause 12, wherein the second oxide block of the polyether polyol (b) or of the polyether polyol (c) comprises copolymerized oxyethylene in an amount of at least 20% to 45% by weight, based on the weight of the second oxide block.
Clause 14. The novel polyether polyol blend of one of Clause 1 to Clause 13, which is free of a polyether polyol having a hydroxyl number of 20 to 240 mg KOH/g, an average functionality of 2 to 8, and which contains at least 50% by weight of copolymerized oxyethylene, based on 100% by weight of the polyether polyol.
Clause 15. A process for preparing the novel polyether polyol blend of one of Clause 1 to Clause 14, having an overall hydroxyl number of 56 mg KOH/g to 140 mg KOH/g, an overall functionality of greater than 2, and having an overall content of copolymerized oxyethylene of from 20 to 40% by weight, comprises blending: (a) monol initiated oxyalkylene ether having a hydroxyl number of less than or equal to 56 mg KOH/g, and containing less than or equal to 20% by weight of copolymerized oxyethylene, based on the total weight of the monol initiated oxyalkylene ether (a), (b) a polyether polyol having a hydroxyl number of 47 mg KOH/g to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10 to 50% by weight of copolymerized oxyethylene content, based on the weight of the second oxide block, and (c) a polyether polyol having a hydroxyl number of 47 mg KOH/g to 300 mg KOH/g, and a nominal functionality of greater than 2 to 8, with the polyether polyol comprising a first oxide block having 20 to 50% by weight of copolymerized oxyethylene content, based on the weight of the polyether polyol at the end of the first oxide block, and a second oxide block comprising 10 to 50% by weight of copolymerized oxyethylene, based on the weight of the second oxide block; wherein the novel polyether polyol blend comprises (i) 20 to 50% by weight of (a) the monol initiated oxyalkylene ether and (ii) 80 to 50% by weight of polyether polyols (b) and (c), with the sum of the %' s by weight of (i) and (ii) totaling 100% by weight of the novel polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight.
Clause 16. A process of preparing the novel in-situ formed polyether polyol blend of one of Clause 2 to Clause 14, having an overall hydroxyl number of 56 mg KOH/g to 140 mg KOH/g, an overall functionality greater than 2, and an overall content of copolymerized oxyethylene of 20% to 40% by weight, comprises: I) introducing into a reaction vessel a mixture comprising (1) an initially charged starter (Sᵢ) comprising a monofunctional compound having a hydroxyl number of less than or equal to 80, and (2) a DMC (double metal cyanide) catalyst; II) feeding (1) an epoxide comprising propylene oxide and ethylene oxide in a weight ratio of 100:0 to 80:20, into the reaction vessel; III) allowing the epoxide mixture and the initially charged starter (Sᵢ) to react and to polymerize by feeding the epoxide until the equivalent weight of the monofunctional compound is increased by at least 10% by weight and reaches a value between 1,500 and 6,000; IV) feeding (1) an epoxide comprising propylene oxide and ethylene oxide in a weight ratio of 78:22 to 45:55; while continuously adding (2) a low equivalent weight continuously added starter (S_{c}) having a nominal functionality of greater than 2 to 6, and an equivalent weight of 28 to 400, into the reaction vessel while continuing to feed epoxide; V) completing addition of the low equivalent weight continuously added starter (S_{c}); VI) feeding (1) an epoxide comprising propylene oxide and ethylene oxide fed at the same ratio as IV)(1) to fully react all the low equivalent weight continuously added starter (S_{c}); VII) allowing the mixture to continue to polymerize in the reaction vessel thereby forming (1) at least two polyether polyols with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1); VIII) feeding (1) an epoxide comprising propylene oxide and ethylene oxide; IX) allowing the mixture to continue to polymerize in the reaction vessel thereby forming (1) at least two polyether polyols with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2), and of epoxide added in VI)(1), and a second oxide block comprising 10 to 50% by weight of copolymerized oxyethylene, based on the weight of epoxide added in VIII)(1); X) thereby forming (1) a novel in-situ formed polyether polyol blend which has an overall hydroxyl number of 56 mg KOH/g to 140 mg KOH/g, an overall functionality of greater than 2, and an overall content of copolymerized oxyethylene of 20% to 40% by weight, and which comprises (a) a monol initiated oxyalkylene ether having a hydroxyl number of less than or equal to 56, and containing less than or equal to 20% by weight of copolymerized oxyethylene, based on 100% by weight of (a), (b) a polyether polyol having a hydroxyl number of 47 to 300 mg KOH/g, and a nominal functionality of 2, with the polyether polyol comprising a first oxide block containing 20 to 50% by weight of copolymerized oxyethylene, based on the weight of the polyether polyol at the end of the first oxide block, and a second oxide block comprising 10% to 50% by weight of copolymerized oxyethylene, based on the weight of the second oxide block, and (c) a polyether polyol having a hydroxyl number of 47 to 300 mg KOH/g, and a nominal functionality of greater than 2 to 8, with the polyether polyol comprising a first oxide block having 20% to 50% by weight of copolymerized oxyethylene, based on the weight of the polyether polyol at the end of the first oxide block, and a second oxide block comprising 10 to 50% by weight of copolymerized oxyethylene, based on the weight of the second oxide block; wherein the novel in-situ formed polyether polyol blend comprises (i) 20% to 50% by weight of (a) the monol initiated oxyalkylene ether, and (ii) 80 to 50% by weight of polyether polyols (b) and (c), with the sum of the %' s by weight totaling 100% by weight of the novel in-situ formed polyether polyol blend, and wherein (ii) the 80 to 50% by weight of polyether polyols (b) and (c) comprises polyether polyol (b) in an amount of from 10 to 90% by weight and polyether polyol (c) in an amount of 90 to 10% by weight.
Clause 17. The process of Clause 16, wherein step VII) forms (1) from 2 to 4 polyether polyols, preferably 2 polyether polyols, with a first alkylene oxide block added to the low equivalent weight continuously added starter (S_{c}) having 20 to 50% by weight of copolymerized oxyethylene content, based on the weight of the amounts of epoxide added in IV)(1), of low equivalent weight continuously added starter (S_{c}) added in IV)(2) and of epoxide added in VI)(1); and/or step IX) forms (1) from 2 to 4 polyether polyols, preferably 2 polyether polyols, with a first alkylene oxide block added to the low equivalent weight continuously added starter (S_{c}) having 20 to 50% by weight of the amounts of epoxide added in IV)(1), of low equivalent weight continuously added starter (S_{c}) added in IV)(2), and of epoxide added in VI)(1), and a second oxide block comprising 10 to 50% by weight of copolymerized oxyethylene, based on the weight of epoxide added in VIII)(1).
Clause 18. The process of forming the novel in-situ formed polyether polyol blend of one of Clause 16 to Clause 17, wherein the initially charged starter (Sᵢ) comprises a polyoxyalkylene monol formed by adding multiple equivalents of an epoxide to a low equivalent weight monofunctional starter.
Clause 19. The process of forming the novel in-situ formed polyether polyol blend of one of Clause 16 to Clause 18, wherein the initially charged starter (Sᵢ) comprises a polyoxypropylene monol having a hydroxyl number of less than or equal to 80 mg KOH/g.
Clause 20. The process of forming the novel in-situ formed polyether polyol blend of one of Clause 16 to Clause 19, wherein the continuously added starter (S_{c}) comprises at least one of glycerin, propylene glycol, dipropylene glycol, ethylene glycol, trimethylolpropane, sucrose, sorbitol, tripropylene glycol, or a low equivalent weight polyol.
Clause 21. The process of forming the novel in-situ formed polyether polyol blend of one of Clause 16 to Clause 20, wherein the continuously added starter (S_{c}) comprises glycerin and propylene glycol.
Clause 22. A viscoelastic foam comprising the reaction product of: (A) toluene diisocyanate, with (B) an isocyanate-reactive component comprising: the novel polyether polyol blend of one of Clause 1 to Clause 14, in the presence of: (C) a blowing agent; (D) a catalyst; and (E) a surfactant.
Clause 23. The viscoelastic foam of Clause 22, wherein (A) the toluene diisocyanate comprises 65% to 10% of the 2,4-isomer and 0% to 35% of the 2,6-isomer of toluene diisocyanate.
Clause 24. The viscoelastic foam of Clause 22 or Clause 23, wherein (B) the isocyanate-reactive component additionally comprises a polyether polyol, a polyether carbonate polyol, a polyesterether polyol, a polymer polyol, a polythioether, a polyacetal, a polycarbonate, or a mixture thereof.
Clause 25. The viscoelastic foam of one of Clause 22 to Clause 24, which additionally comprises a foam modifier.
Clause 26. The viscoelastic foam of one of Clause 22 to Clause 25, wherein (C) said blowing agent comprises water, acetone, carbon dioxide, a chlorofluorocarbon, a highly fluorinated hydrocarbon, a perfluorinated hydrocarbon, a chlorinated hydrocarbon, an aliphatic hydrocarbon, a cycloaliphatic hydrocarbon, or a mixture thereof.
Clause 27. The viscoelastic foam of one of Clause 22 to Clause 26, wherein the blowing agent is present in an amount of 0.5% to 20% by weight, or 0.75% to 10% by weight, based on 100% by weight of component (B).
Clause 28. The viscoelastic foam of one of Clause 22 to Clause 27, wherein the surfactant comprises a silicone surfactant.
Clause 29. The viscoelastic foam of one of Clause 22 to Clause 28, wherein the surfactant is present in an amount of 0.1 to 4 parts by weight, or 0.2 to 3 parts by weight, based on 100 parts by weight of component (B).
Clause 30. The viscoelastic foam of one of Clause 22 to Clause 29, wherein the catalyst comprises an organoamine compound and/or an organotin compound.
Clause 31. The viscoelastic foam of one of Clause 22 to Clause 30, wherein the catalyst is present in an amount of 0.01 to 3 parts by weight, or 0.1 to 2 parts by weight, based on 100 parts by weight of component (B).
Clause 32. The viscoelastic foam of one of Clause 22 to Clause 31, additionally comprising a flame retardant, an antioxidant, a pigment, a dye, a filler, or a mixture thereof.
Clause 33. A process for preparing the viscoelastic foam of one of Clause 22 to Clause 32 comprising reacting (A) toluene diisocyanate, with (B) an isocyanate-reactive component comprising the novel polyether polyol blend of Clause 1 to Clause 14, in the presence of (C) a blowing agent, (D) a catalyst, and (E) a surfactant.

The following examples further illustrate details for the process of this invention. The invention, which is set forth in the foregoing disclosure, is not to be limited either in spirit or scope by these examples. Those skilled in the art will readily understand that known variations of the conditions of the following procedures can be used. Unless otherwise noted, all temperatures are degrees Celsius and all parts and percentages are parts by weight and percentages by weight, respectively.

### EXAMPLES

Test Methods: The physical properties reported herein were measured per the standard procedures described in ASTM D3574-17 having the title “Standard Test Methods for Flexible Cellular Materials—Slab, Bonded, and Molded Urethane Foams” unless otherwise stated.

Hydroxyl Numbers: The hydroxyl numbers were determined in accordance with ASTM D-4274-11, and are reported in mg KOH/g polyol.

Viscosity: The viscosities of the polyether polyols were determined at 25° C. using an Anton Paar SVM 3000/G2 Stabinger Viscometer.

Other foam physical properties reported herein were measured per the standard procedures described in ASTM D3574-17.

As used herein, “pphp” represents parts per hundred parts polyol.

The following materials were used in the working examples:
The following materials were used in the working examples:
Isocyanate A: toluene diisocyanate having 80% of 2,4-isomer and 20% of 2,6-isomer
Polyether Polyol A: An in-situ formed multifunctional polyether polyol prepared by alkoxylating a monol, diol, and triol with a DMC catalyst following the procedure described in U.S. Pat. No. 6,491,846. The starter comprises a 1600 MW (35 OH#) monol made from the propoxylation of Neodol 25. 3390 g of this 1600 MW monol are alkoxylated with 3287 g of a mixture of propylene oxide and ethylene oxide in a weight ratio of 82/18 to a hydroxyl number of about 17.8 mg KOH/g. The alkoxide mixture was charged at a combined feed rate of 60.26 g/min. The resulting 17.8 hydroxyl number monol contains a total of 8.5% ethylene oxide. Next, a mixture of 1107 g glycerin and propylene glycol in a 62.3 to 37.7 wt % ratio was continuously added at a combined feed rate of 7.91 g/min along with mixture of 8437 g propylene oxide and ethylene oxide in a weight ratio of 82/18 until a hydroxyl number of about 123 was reached. The alkoxide mixture was charged at a combined feed rate of 60.26 g/min. At this point, the propylene glycol and glycerin feeds were stopped and an additional 441 g of the propylene oxide and ethylene oxide mixture were continuously added until a hydroxyl number of about 120 was reached. At this point the reactor contains a mixture of the previously mentioned 17.8 hydroxyl number monol, a diol intermediate with a hydroxyl number of 187 mg KOH/g and a triol intermediate with a hydroxyl number of 187 mg KOH/g. At this point 3333 g of a mixture of propylene oxide and ethylene oxide were continuously added in a weight ratio of 55/45 at a combined feed rate of 60.26 g/min until the hydroxyl number of the diol and triol components reached about 140 mg KOH/g. The diol and triol components each contain 16% ethylene oxide in the first block, based on the weight of the polyether polyol at the end of the first oxide block, and 45% ethylene oxide in the second oxide block, based on the weight of the second oxide block. This in-situ formed polyether polyol blend contains 33 weight % monol, 22 weight % diol and 45 weight % triol. The in-situ formed polyether polyol blend had an overall functionality of about 2.4, total ethylene oxide content of 18.5% and an overall hydroxyl number of about 100.
Polyether Polyol B: A novel in-situ formed multifunctional polyether polyol blend prepared by alkoxylating a monol, diol, and triol with a DMC catalyst following the procedure described herein. The starter comprises a 1600 MW (35 OH#) monol made from the propoxylation of Neodol 25. 3390 g of this 1600 MW monol are alkoxylated with 3287 g of a mixture of propylene oxide and ethylene oxide in a weight ratio of 82/18 to a hydroxyl number of about 17.8 mg KOH/g. The alkoxide mixture was charged at a combined feed rate of 60.26 g/min. The resulting 17.8 hydroxyl number monol contains a total of 8.5% ethylene oxide. Next, a mixture of 1107 g glycerin and propylene glycol in a 62.3 to 37.7 wt % ratio was continuously added at a combined feed rate of 7.91 g/min along with mixture of 8437 g propylene oxide and ethylene oxide in a weight ratio of 60.6/39.4 until a hydroxyl number of about 123 was reached. The alkoxide mixture was charged at a combined feed rate of 60.26 g/min. At this point, the propylene glycol and glycerin feeds were stopped and an additional 441 g of the propylene oxide and ethylene oxide mixture were continuously added until a hydroxyl number of about 120 was reached. At this point the reactor contains a mixture of the previously mentioned 17.8 hydroxyl number monol, a diol intermediate with a hydroxyl number of 187 mg KOH/g and a triol intermediate with a hydroxyl number of 187 mg KOH/g. At this point 3333 g of a mixture of propylene oxide and ethylene oxide were continuously added in a weight ratio of 68.5/31.5 at a combined feed rate of 60.26 g/min until the hydroxyl number of the diol and triol components reached about 140 mg KOH/g. The diol and triol components each contain 35% ethylene oxide in the first block, based on the weight of the polyether polyol at the end of the first oxide block, and 31.5% ethylene oxide in the second oxide block, based on the weight of the second oxide block. This novel in-situ formed polyether polyol blend contains 33 weight % monol, 22 weight % diol and 45 weight % triol. The novel in-situ formed polyether polyol blend had an overall functionality of about 2.4, total ethylene oxide content of 25.5% and an overall hydroxyl number of about 100.
Polyether Polyol C: An in-situ formed multifunctional polyether polyol prepared by alkoxylating a monol, diol, and triol with a DMC catalyst with the following procedure. The starter comprises a 1600 MW (35 OH#) monol made from the propoxylation of Neodol 25. 3390 g of this 1600 MW monol are alkoxylated with 3287 g of a mixture of propylene oxide and ethylene oxide in a weight ratio of 30/70 to a hydroxyl number of about 17.8 mg KOH/g. The alkoxide mixture was charged at a combined feed rate of 60.26 g/min. The resulting 17.8 hydroxyl number monol contains a total of 33.3% ethylene oxide. Next, a mixture of 1107 g glycerin and propylene glycol in a 62.3 to 37.7 wt % ratio was continuously added at a combined feed rate of 7.91 g/min along with mixture of 8437 g propylene oxide and ethylene oxide in a weight ratio of 82/18 until a hydroxyl number of about 123 was reached. The alkoxide mixture was charged at a combined feed rate of 60.26 g/min. At this point, the propylene glycol and glycerin feeds were stopped and an additional 441 g of the propylene oxide and ethylene oxide mixture were continuously added until a hydroxyl number of about 120 was reached. At this point the reactor contains a mixture of the previously mentioned 17.8 hydroxyl number monol, a diol intermediate with a hydroxyl number of 187 mg KOH/g and a triol intermediate with a hydroxyl number of 187 mg KOH/g. At this point 3333 g of a mixture of propylene oxide and ethylene oxide were continuously added in a weight ratio of 55/45 at a combined feed rate of 60.26 g/min until the hydroxyl number of the diol and triol components reached about 140 mg KOH/g. The diol and triol components each contain 16% ethylene oxide in the first block, based on the weight of the polyether polyol at the end of the first oxide block, and 45% ethylene oxide in the second oxide block, based on the weight of the second oxide block. This in-situ formed polyether polyol blend contains 33 weight % monol, 22 weight % diol and 45 weight % triol. The in-situ formed polyether polyol blend had an overall functionality of about 2.4, total ethylene oxide content of 26.6% and an overall hydroxyl number of about 100.
Polyether Polyol D: A novel in-situ formed multifunctional polyether polyol prepared by alkoxylating a monol, diol, and triol with a DMC catalyst following the procedure described herein. The starter comprises a 1600 MW (35 OH#) monol made from the propoxylation of Neodol 25. 3390 g of this 1600 MW monol are alkoxylated with 3287 g of a mixture of propylene oxide and ethylene oxide in a weight ratio of 82/18 to a hydroxyl number of about 17.8 mg KOH/g. The alkoxide mixture was charged at a combined feed rate of 60.26 g/min. The resulting 17.8 hydroxyl number monol contains a total of 8.5% ethylene oxide. Next, a mixture of 1107 g glycerin and propylene glycol in a 62.3 to 37.7 wt % ratio was continuously added at a combined feed rate of 7.91 g/min along with mixture of 8437 g propylene oxide and ethylene oxide in a weight ratio of 55/45 until a hydroxyl number of about 123 was reached. The alkoxide mixture was charged at a combined feed rate of 60.26 g/min. At this point, the propylene glycol and glycerin feeds were stopped and an additional 441 g of the propylene oxide and ethylene oxide mixture were continuously added until a hydroxyl number of about 120 was reached. At this point the reactor contains a mixture of the previously mentioned 17.8 hydroxyl number monol, a diol intermediate with a hydroxyl number of 187 mg KOH/g and a triol intermediate with a hydroxyl number of 187 mg KOH/g. At this point 3333 g of a mixture of propylene oxide and ethylene oxide were continuously added in a weight ratio of 55/45 at a combined feed rate of 60.26 g/min until the hydroxyl number of the diol and triol components reached about 140 mg KOH/g. The diol and triol components each contain 40% ethylene oxide in the first block, based on the weight of the polyether polyol at the end of the first oxide block, and 45% ethylene oxide in the second oxide block, based on the weight of the second oxide block. This novel in-situ formed polyether polyol blend contains 33 weight % monol, 22 weight % diol and 45 weight % triol. The novel in-situ formed polyether polyol blend had an overall functionality of about 2.4, total ethylene oxide content of 30.3% and an overall hydroxyl number of about 100.
Polyol E: A glycerin started poly(oxypropyleneoxyethylene) polyol having a hydroxyl number of about 37, and containing about 73% of copolymerized oxyethylene
Polyol F: A glycerin starter poly(oxypropylene) polyol having a hydroxyl number of about 168
Foam Modifier A: A foam modifier having a hydroxyl number of about 1240 mg KOH/g polyol, commercially available from Momentive Performance Materials as Arcol DP-1022
Foam Modifier A: A delayed action crosslinking agent available from Evonik Industries as Ortegol 204
Surfactant A: A silicone surfactant commercially available from Momentive Performance Materials as Niax L-618
Catalyst A: An amine catalyst, commercially available from Momentive Performance Materials as Niax A-33
Catalyst B: An amine catalyst, commercially available from Momentive Performance Materials as Niax A-1
Catalyst C: Tin octoate, commercially available from Evonik as Dabco T-9
Isocyanate A: Toluene diisocyanate having 80% of the 2,4 isomer and 20% of the 2,6 isomer

The free-rise bench scale foams of Table 1 were prepared using the following procedure. The polyether polyols, water, silicone surfactants, amine catalysts, and any other non-isocyanate additives were added to a cylindrical container fitted with baffles. The contents were mixed at 2400 rpm for 60 seconds with an agitator having two turbine impellers. Tin Catalyst C, if employed, was added at this time. The mixture was then degassed for 15 seconds. After degassing, the contents were mixed at 2400 rpm for 15 seconds, during which period the isocyanate was added when about 10 seconds of mixing time remained. The mixture was then poured into a 14×14×6-inch cardboard box, where it rose freely until the reaction was complete. A batch size sufficient to give a bun at least about 6 inches high was employed. The freshly prepared bun was cured for 20 minutes in an oven at 120° C. and then allowed to cure at ambient conditions for a minimum of 1 day. Observations made during foaming and curing are set forth in the Tables. The buns were then trimmed to 12×12×4 inches and were roller crushed 3 times to a minimum thickness of about 0.5 inches. These samples were then conditioned for at least 16 hours at standard temperature (˜23° C.) and humidity (˜50%) before being tested.

TABLE 1
Polyether Polyol Compositions:

| | Polyether | Polyether | Polyether | Polyether |
|---|---|---|---|---|
| Polyether Polyol | Polyol A | Polyol B | Polyol C | Polyol D |
| EO/PO ratio in (a) | 18/82 | 18/82 | 70/30 | 18/82 |
| monol oxide cofeed | | | | |
| % EO in (a) monol | 8.5% | 8.5% | 33.3% | 8.5% |
| (based on total | | | | |
| weight) | | | | |
| EO/PO ratio in first | 18/82 | 39.4/60.6 | 18/82 | 45/55 |
| block oxide cofeed | | | | |
| % EO in Diol and | 16 | 35 | 16 | 40 |
| Triol Intermediate | | | | |
| (based on weight at | | | | |
| end of first oxide | | | | |
| block) | | | | |
| EO/PO ratio in the | 45/55 | 31.5/68.5 | 45/55 | 45/55 |
| second block | | | | |
| % EO in in the | 45 | 31.5 | 45 | 45 |
| second block | | | | |
| (based on oxide | | | | |
| weight fed) | | | | |
| Total % EO in (b) | 23 | 34 | 45 | 45 |
| and (c) (based on | | | | |
| total weight of (b) | | | | |
| and (c)) | | | | |
| Total % EO in | 18.5 | 25.5 | 26.6 | 30.3 |
| Polyether Polyol | | | | |
| blend (include EO | | | | |
| in monol) (based | | | | |
| on total weight of | | | | |
| polyether polyol | | | | |
| blend, i.e. (a), (b) | | | | |
| and (c)) | | | | |

TABLE 2A
Foam Formulations:

| Isocyanate-Reactive | Example 1 | Example | Example 3 | Example |
|---|---|---|---|---|
| Component | (Comparative) | 2 | (Comparative) | 4 |
| Polyether Polyol A | 100 | | | |
| Polyether Polyol B | | 100 | | |
| Polyether Polyol C | | | 100 | |
| Polyether Polyol D | | | | 100 |
| Surfactant A | 0.5 | 0.5 | 0.5 | 0.5 |
| Foam Modifier A | | | | |
| Water (distilled) | 1.25 | 1.25 | 1.25 | 1.25 |
| Catalyst A | 0.60 | 0.60 | 0.60 | 0.60 |
| (Niax A-33) | | | | |
| Catalyst B | 0.03 | 0.03 | 0.03 | 0.03 |
| (Niax A-1) | | | | |
| Catalyst C | 0.03 | 0.03 | 0.03 | 0.03 |
| (Dabco T-9) | | | | |
| A-Side (Isocyanate) | | | | |
| Isocyanate A | 26.69 | 26.58 | 26.58 | 26.3 |
| Isocyanate Index | 95 | 95 | 95 | 95 |

TABLE 2B
Foam Formulations

| Isocyanate- | | | | |
|---|---|---|---|---|
| Reactive | Example 5 | Example 6 | Example 7 | Example |
| Component | (Comparative) | (Comparative) | (Comparative) | 8 |
| Polyether | 83.00 | | | |
| Polyol A | | | | |
| Polyether | | 83.00 | | |
| Polyol C | | | | |
| Polyether | | | 83.00 | 90.00 |
| Polyol D | | | | |
| Polyol E | 7.00 | 7.00 | 7.00 | |
| Polyol F | 10.00 | 10.00 | 10.00 | 10.00 |
| Surfactant A | 0.8 | 0.8 | 0.8 | 0.8 |
| Foam | 1.50 | 1.50 | 1.50 | 1.50 |
| Modifier A | | | | |
| Foam | 0.60 | 0.60 | 0.60 | 0.60 |
| Modifier B | | | | |
| Water | 1.10 | 1.10 | 1.10 | 1.10 |
| (distilled) | | | | |
| Catalyst A | 0.58 | 0.58 | 0.58 | 0.58 |
| Catalyst B | 0.07 | 0.07 | 0.07 | 0.07 |
| Catalyst C | 0.03 | 0.03 | 0.03 | 0.03 |
| A-Side | | | | |
| (Isocyanate) | | | | |
| Isocyanate A | 32.16 | 32.05 | 31.81 | 32.47 |
| Isocyanate | 100.00 | 100.00 | 100.00 | 100.00 |
| Index | | | | |

TABLE 3A
Foam Properties

| Physical | | Example 1 | Example | Example 3 | Example |
|---|---|---|---|---|---|
| Properties | Units | (Comparative) | 2 | (Comparative) | 4 |
| Density | kg/m³ | 61.23 | 61.72 | 63.32 | 65.08 |
| | (lb/ft³) | (3.82) | (3.85) | (3.95) | (4.06) |
| Airflow | m³/min | 0.07 | 0.14 | 0.04 | 0.20 |
| | (ft³/min) | (2.62) | (4.85) | (1.54) | (7.03) |
| IFD | cm (in) | 10.24 | 10.19 | 9.96 | 10.21 |
| Thickness | | (4.03) | (4.01) | (3.92) | (4.02) |
| IFD 25% | N (lbf) | 50.92 | 38.65 | 50.47 | 22.7 |
| | | (11.46) | (8.70) | (11.36) | (5.11) |
| IFD 65% | N (lbf) | 109.88 | 84.02 | 119.29 | 52.43 |
| | | (24.73) | (18.91) | (26.85) | (11.80) |
| IFD 25% | N (lbf) | 42.12 | 34.34 | 42.56 | 20.22 |
| Return | | (9.48) | (7.73) | (9.58) | (4.55) |
| Return | % | 82.68 | 88.84 | 84.33 | 89.04 |
| Val. 25% | | | | | |
| S.F. | NA | 2.16 | 2.18 | 2.37 | 2.31 |
| 65%/25% | | | | | |
| Tensile | kPa | 34.60 | 42.19 | 30.33 | 31.36 |
| Strength | (psi) | (5.02) | (6.12) | (4.40) | (4.55) |
| Elongation | % | 174.60 | 211.15 | 148.60 | 167.45 |
| Tear | N/m | 133.14 | 159.41 | 92.84 | 145.40 |
| Strength | (pli) | (0.76) | (0.91) | (0.53) | (0.83) |
| (20″/MIN- | | | | | |
| STDSP1) | | | | | |
| 75% | % | 6.25 | 2.32 | 14.89 | 2.17 |
| Com- | | | | | |
| pression | | | | | |
| Set | | | | | |
| 90% | % | 81.07 | 3.03 | 76.75 | 3.03 |
| Com- | | | | | |
| pression | | | | | |
| Set | | | | | |
| 75% | % | 7.55 | 4.52 | 17.07 | 7.82 |
| HACS | | | | | |
| Resilience | % | 5.80 | 10.80 | 11.80 | 12.50 |
| (Ball | | | | | |
| Rebound) | | | | | |
| 50% | % | 3.83 | 1.25 | 2.48 | 1.32 |
| Wet Set | | | | | |
| 75% | % | 4.78 | 1.55 | 0.85 | 1.92 |
| Wet Set | | | | | |
| 90% | % | 4.32 | 1.28 | 4.22 | 0.80 |
| Wet Set | | | | | |

TABLE 3B
Foam Properties

| Physical | | Example 5 | Example 7 | Example |
|---|---|---|---|---|
| Properties | Units | (Comparative) | (Comparative) | 8 |
| Density | kg/m³ | 60.91 (3.80) | 64.12 (4.00) | 62.36 (3.89) |
| | (lb/ft³) | | | |
| Airflow | m³/min | 0.12 (4.08) | 0.20 (7.21) | 0.18 (6.32) |
| | (ft³/min) | | | |
| IFD Thickness | cm (in) | 10.52 (4.14) | 10.59 (4.17) | 10.06 (3.96) |
| IFD 25% | N (lbf) | 51.09 (11.50) | 30.75 (6.92) | 32.63 (7.35) |
| IFD 65% | N (lbf) | 112.94 (25.42) | 72.78 (16.38) | 74.64 (16.80) |
| IFD 25% | N (lbf) | 46.96 (10.57) | 29.15 (6.56) | 31.08 (7.00) |
| Return | | | | |
| Return Val. | % | 91.96 | 94.73 | 95.24 |
| 25% | | | | |
| S.F. 65%/25% | NA | 2.21 | 2.37 | 2.29 |
| Tensile | kPa | 59.14 (8.58) | 73.20 (10.62) | 66.97 (9.72) |
| Strength | (psi) | | | |
| Elongation | % | 225.90 | 273.75 | 273.05 |
| Tear Strength | N/m | 185.69 (1.06) | 218.97 (1.25) | 219.85 (1.26) |
| (20″/MIN- | (pli) | | | |
| STDSP1) | | | | |
| 75% | % | 1.77 | 0.75 | 1.18 |
| Compression | | | | |
| Set | | | | |
| 90% | % | 1.78 | 1.27 | 1.12 |
| Compression | | | | |
| Set | | | | |
| 75% HACS | % | 1.22 | 4.13 | 1.32 |
| Resilience | % | 3.60 | 6.40 | 4.00 |
| (Ball Rebound) | | | | |
| 50% Wet Set | % | 0.95 | 0.28 | 0.10 |
| 75% Wet Set | % | 0.93 | 0.05 | 0.10 |
| 90% Wet Set | % | 1.12 | 0.25 | 0.18 |

*Foams made from Polyether Polyol C using the formulation in Example 6 (Comparative) could not be tested due to the foam shrinking. Examples 5, 7 and 8 demonstrate that the increased amount of ethylene oxide in the first oxide block of polyether polyol (b) and of polyether polyol (c) is necessary to achieve good results and to eliminate the need for an additional polyether polyol that contains a high ethylene oxide content in the foam formulation.

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

1-2. (canceled)

3. The viscoelastic foam of claim 18, wherein the overall hydroxyl number of the polyether polyol blend is 80 mg KOH/g to 120 mg KOH/g and the overall functionality is greater than 2 to 3.

4. The viscoelastic foam of claim 18, wherein the monol initiated oxyalkylene ether (a) has a hydroxyl number of less than or equal to 28 mg KOH/g and contains from 2 to 15% by weight of copolymerized oxyethylene, based on the total weight of monol initiated oxyalkylene ether (a).

5. The viscoelastic foam of claim 18, wherein the polyether polyol (b) has a hydroxyl number of 70 to 240 mg KOH/g, and comprises 25% to 45% by weight of copolymerized oxyethylene in the first oxide block, based on the weight of the polyether polyol at the end of the first oxide block, and 15% to 45% by weight of copolymerized oxyethylene in the second oxide block, based on the weight of the second oxide block; and the polyether polyol (c) has a hydroxyl number of 70 to 240 mg KOH/g, a nominal functionality of 3 to 6, and comprises 25% to 45% by weight of copolymerized oxyethylene in the first oxide block, based on the weight of the polyether polyol at the end of the first oxide block, and 15% to 45% by weight of copolymerized oxyethylene in the second oxide block, based on the weight of the second oxide block.

6. The viscoelastic foam of claim 18, wherein the first oxide block of polyether polyol (b) is formed by the copolymerization of ethylene oxide and propylene oxide in the presence of a low equivalent weight starter having a nominal functionality of 2; and the first oxide block of polyether polyol (c) is formed by the copolymerization of ethylene oxide and propylene oxide in the presence of a low equivalent weight starter having a nominal functionality of greater than 2 to 8.

7. The viscoelastic foam of claim 18, wherein the second oxide block of polyether polyol (b) and/or of polyether polyol (c) comprises 20% to 45% by weight of copolymerized oxyethylene, based on the weight of the second oxide block.

8. The viscoelastic foam of claim 18, comprising (i) from 25 to 40% by weight of the monol initiated oxyalkylene ether (a), and (ii) from 75 to 60% by weight of polyether polyols (b) and (c), wherein the 75 to 60% by weight of polyether polyols (b) and (c) comprises polyether polyol (b) in an amount of 30 to 70% by weight, and polyether polyol (c) in an amount of 70 to 30% by weight.

9. The viscoelastic foam of claim 18, with the proviso that the isocyanate-reactive component is free of a polyether polyol having a hydroxyl number of 20 to 240 mg KOH/g, an average functionality of 2 to 8, and which contains at least 50% by weight of copolymerized oxyethylene, based on 100% by weight of the polyether polyol.

10-17. (canceled)

18. A viscoelastic foam comprising the reaction product of:
(A) toluene diisocyanate,
with
(B) an isocyanate-reactive component comprising a polyether polyol blend,
in the presence of:
(C) a blowing agent;
(D) a catalyst;
and
(F) a surfactant,
wherein the polyether polyol blend has an overall hydroxyl number of 56 mg KOH/g to 140 mg KOH/g, an overall functionality of greater than 2, and an overall content of copolymerized oxyethylene of 20% to 40% by weight, and comprises:
(a) a monol initiated oxyalkylene ether having a hydroxyl number of less than or equal to 56 mg KOH/g polyol, and containing less than or equal to 20% of copolymerized oxyethylene, based on the total weight of monol initiated oxyalkylene ether (a);
(b) a polyether polyol having a hydroxyl number of 47 mg KOH/g to 300 mg KOH/g, and a nominal functionality of 2, wherein the polyether polyol comprises a first oxide block containing 20% to 50% by weight of copolymerized oxyethylene, based on the weight of the polyether polyol at the end of the first oxide block, and a second oxide block comprising 10% to 50% by weight of copolymerized oxyethylene, based on the weight of the second oxide block; and
(c) a polyether polyol having a hydroxyl number of 47 mg KOH/g to 300 mg KOH/g, and a nominal functionality of greater than 2 to 8, wherein the polyether polyol comprises a first oxide block having 20% to 50% by weight of copolymerized oxyethylene, based on the weight of the polyether polyol at the end of the first oxide block, and a second oxide block comprising 10% to 50% by weight of copolymerized oxyethylene, based on the weight of the second oxide block;
wherein the polyether polyol blend comprises (i) from 20% to 50% by weight of (a) said monol initiated oxyalkylene ether, and (ii) from 80 to 50% by weight of polyether polyols (b) and (c), with the sum of the %' s by weight of (i) and (ii) totaling 100% by weight of the polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight; and
with the proviso that the isocyanate-reactive component does not include a polymer polyol.

19. (canceled)

20. A process for the preparation of a viscoelastic foam comprising reacting:
(A) toluene diisocyanate,
with
(B) an isocyanate-reactive component comprising a polyether polyol blend,
in the presence of:
(C) a blowing agent;
(D) a catalyst;
and
(E) a surfactant,
wherein the polyether polyol blend has an overall hydroxyl number of 56 mg KOH/g to 140 mg KOH/g, an overall functionality of greater than 2, and an overall content of copolymerized oxyethylene of 20% to 40% by weight, and comprises:
(a) a monol initiated oxyalkylene ether having a hydroxyl number of less than or equal to 56 mg KOH/g polyol, and containing less than or equal to 20% of copolymerized oxyethylene, based on the total weight of monol initiated oxyalkylene ether (a);
(b) a polyether polyol having a hydroxyl number of 47 mg KOH/g to 300 mg KOH/g, and a nominal functionality of 2, wherein the polyether polyol comprises a first oxide block containing 20% to 50% by weight of copolymerized oxyethylene, based on the weight of the polyether polyol at the end of the first oxide block, and a second oxide block comprising 10% to 50% by weight of copolymerized oxyethylene, based on the weight of the second oxide block; and
(c) a polyether polyol having a hydroxyl number of 47 mg KOH/g to 300 mg KOH/g, and a nominal functionality of greater than 2 to 8, wherein the polyether polyol comprises a first oxide block having 20% to 50% by weight of copolymerized oxyethylene, based on the weight of the polyether polyol at the end of the first oxide block, and a second oxide block comprising 10% to 50% by weight of copolymerized oxyethylene, based on the weight of the second oxide block;
wherein the polyether polyol blend comprises (i) from 20% to 50% by weight of (a) said monol initiated oxyalkylene ether, and (ii) from 80 to 50% by weight of polyether polyols (b) and (c), with the sum of the %' s by weight of (i) and (ii) totaling 100% by weight of the polyether polyol blend, and wherein (ii) the 80 to 50% by weight of polyether polyols (b) and (c) comprises polyether polyol (b) in an amount of 10 to 90% by weight and polyether polyol (c) in an amount of 90 to 10% by weight; and
with the proviso that the isocyanate-reactive component does not include a polymer polyol.

21. The process of claim 20, wherein the polyether polyol blend is an in-situ formed polyether polyol blend.

22. The process of claim 20, wherein the overall hydroxyl number of the polyether polyol blend is 80 mg KOH/g to 120 mg KOH/g and the overall functionality is greater than 2 to 3.

23. The process of claim 20, wherein the monol initiated oxyalkylene ether (a) has a hydroxyl number of less than or equal to 28 mg KOH/g and contains from 2 to 15% by weight of copolymerized oxyethylene, based on the total weight of monol initiated oxyalkylene ether (a).

24. The process of claim 20, wherein the polyether polyol (b) has a hydroxyl number of 70 to 240 mg KOH/g, and comprises 25% to 45% by weight of copolymerized oxyethylene in the first oxide block, based on the weight of the polyether polyol at the end of the first oxide block, and 15% to 45% by weight of copolymerized oxyethylene in the second oxide block, based on the weight of the second oxide block; and the polyether polyol (c) has a hydroxyl number of 70 to 240 mg KOH/g, a nominal functionality of 3 to 6, and comprises 25% to 45% by weight of copolymerized oxyethylene in the first oxide block, based on the weight of the polyether polyol at the end of the first oxide block, and 15% to 45% by weight of copolymerized oxyethylene in the second oxide block, based on the weight of the second oxide block.

25. The process of claim 20, wherein the first oxide block of polyether polyol (b) is formed by the copolymerization of ethylene oxide and propylene oxide in the presence of a low equivalent weight starter having a nominal functionality of 2; and the first oxide block of polyether polyol (c) is formed by the copolymerization of ethylene oxide and propylene oxide in the presence of a low equivalent weight starter having a nominal functionality of greater than 2 to 8.

26. The process of claim 20, wherein the second oxide block of polyether polyol (b) and/or of polyether polyol (c) comprises 20% to 45% by weight of copolymerized oxyethylene, based on the weight of the second oxide block.

27. The process of claim 20, comprising (i) from 25 to 40% by weight of the monol initiated oxyalkylene ether (a), and (ii) from 75 to 60% by weight of polyether polyols (b) and (c), wherein the 75 to 60% by weight of polyether polyols (b) and (c) comprises polyether polyol (b) in an amount of 30 to 70% by weight, and polyether polyol (c) in an amount of 70 to 30% by weight.

28. The process of claim 20, with the proviso that the isocyanate-reactive component is free of a polyether polyol having a hydroxyl number of 20 to 240 mg KOH/g, an average functionality of 2 to 8, and which contains at least 50% by weight of copolymerized oxyethylene, based on 100% by weight of the polyether polyol.
